(19) United States
(12) Patent Application Publication
(10) Pub. No.: US 2008/0125572 A1
(43) Pub. Date: May 29, 2008

(54) POLYCHLOROPRENE-BASE LATEX AND METHOD FOR PRODUCING IT

(75) Inventor: Shinji OZOE, Shunan-shi (JP)

Correspondence Address: SUGHRUE-265550, 2100 PENNSYLVANIA AVE. NW, WASHINGTON, DC, 20037-3213, US

(73) Assignee: TOSOH CORPORATION, Shunan-shi (JP)

(21) Appl. No.: 11/946,201

(22) Filed: Nov. 28, 2007

(30) Foreign Application Priority Data
Nov. 29, 2006 (JP) 2006-321500
Mar. 20, 2007 (JP) 2007-072065

(51) Int. Cl. C08G 75/00

(52) U.S. Cl. 528/391

(57) ABSTRACT

To provide a polychloroprene-base latex having improved adhesiveness and water resistance over conventional polychloroprene-base latex adhesives.

A polychloroprene-base latex containing 2% or less by weight of a conventional emulsifier, and an acid functional group-terminated polychloroprene-type polymer represented by the following formula (1) or a polychloroprene-base random copolymer with hydrophilic group, and a method for producing the polychloroprene-base latex:

(polychloroprene-type polymer)-S—R—X (1)

(wherein X represents a carboxyl group or its salt; represents an alkyl group, an aryl group, a substituted alkyl group or a substituted aryl group).

### FIELD OF THE INVENTION

The present invention relates to a polychloroprene-base latex, in which the emulsifier is reduced and which has extremely improved adhesiveness and water resistance, and to a method for producing it.

### BACKGROUND ART

Polychloroprene (hereinafter this may be abbreviated as CR)-base adhesives and primers are CR applications in which is made the best use of the characteristics such as the polarity, the cohesive strength and the flexibility of CR, and are given an important post in a broad field of construction materials, woodwork materials, shoemaking materials, vehicle materials and household work materials, as the mainstream of rubber-base adhesives. A mainstream of conventional CR-base adhesives is a type comprising CR, a tackifier resin, zinc oxide and an antioxidant dissolved in an organic solvent such as toluene, hexane, ethyl acetate, cyclohexane; but with the increase in the interest in the environmental problem, the demand for solvent-free adhesives is increasing year by year. To satisfy the requirement, a CR latex has been specifically noted, but the conventional CR latex is insufficient in point of its adhesiveness and water resistance, and it could not as yet be substitutable for solvent CR adhesives.

A conventional CR latex is produced according to a method that comprises emulsifying chloroprene in water by the use of an emulsifier such as rosined soap, sodium alkylsulfate, sodium higher alcohol sulfate ester, polyoxyethylene alkyl ether, alkylamine salt, quaternary ammonium salt or polyvinyl alcohol, followed by adding a radical initiator such as potassium persulfate to polymerize chloroprene, and then removing the unreacted monomer by steam stripping. The latex contains the above-mentioned emulsifier in an amount of about 5% by weight of CR, and this may be the main factor that retards the expression of adhesiveness and water resistance of the conventional CR latex adhesive. Specifically, it may be considered that the emulsifier desorbed from the surfaces of the CR latex particles in a process of applying a conventional CR latex-base adhesive to a subject and drying it and the free emulsifier dissolved in water may align on the surface of the adhesive film or in the interface between the adhesive and the subject, thereby interfering with the adhesiveness intrinsic to CR. Accordingly, a trial has been made of producing a soapless CR latex not containing such an emulsifier. For example, disclosed are a method of radical-copolymerizing styrene and acrylic acid in water, then neutralizing it with ammonia, and thereafter adding chloroprene thereto for emulsion polymerization to give a soapless CR latex (Patent Reference 1); and a method of radical-copolymerizing chloroprene and an active chlorine-having monomer in water in the presence of an amine to give a soapless CR latex (Patent Reference 2).

However, the hydrophilic group-having copolymers for use in emulsification of chloroprene both have poor hydrophilic/lipophilic balance; and in the former case, a styrene-base hydrophilic group-having polymer that is heterogeneous to CR is used, and therefore this has a drawback of detracting from the adhesiveness intrinsic to CR.

Also disclosed is a production method for a polymethacrylate-base microemulsion, which comprises radically polymerizing methyl methacrylate in the presence of a carboxyl group-having thiol compound thereby producing a carboxyl group-terminated polymethacrylic acid and using it as an emulsifier (Patent Reference 3).

However, nothing is described relating to emulsion polymerization of chloroprene and to adhesive potency of polychloroprene-base latex, and nothing is referred to relating to the effect of addition of hydrophilic solvent.

[Patent Reference 1] JP-A 58-89602

[Patent Reference 2] JP-B 52-32987

[Patent Reference 3] JP-T 10-506428

### SUMMARY OF THE INVENTION

As in the above, earnestly desired is a novel CR latex having improved adhesiveness and water resistance over those of conventional CR-base latex adhesive.

The present inventors have assiduously studied for solving the above-mentioned problems and, as a result, have found that, when chloroprene or chloroprene and a monomer copolymerizable with chloroprene are subjected to emulsion polymerization, using an acid functional group-terminated polychloroprene-type polymer (hereinafter abbreviated as acid group-terminated CR) in the presence of a suitable amount of a hydrophilic solvent, or when chloroprene or chloroprene and a monomer copolymerizable with chloroprene are subjected to emulsion polymerization, using a polychloroprene-base random copolymer with hydrophilic group (hereinafter abbreviated as CR random copolymer with hydrophilic group), then a CR latex may be obtained in which the amount of the conventional emulsifier used is greatly reduced or which does not contain the emulsifier at all, therefore capable of solving the prior-art problems, and thus have completed the present invention.

Specifically, the invention has the following constitution:

1) A polychloroprene-base latex comprising 2% or less by weight of a conventional emulsifier, and an acid functional group-terminated polychloroprene-type polymer represented by the following formula (1):

(polychloroprene-type polymer)-S—R—X (1)

(wherein X represents a carboxyl group or its salt; R represents an alkyl group, an aryl group, a substituted alkyl group or a substituted aryl group).

2. The polychloroprene-base latex according to the above 1), wherein the acid functional group-terminated polychloroprene-type polymer is a polychloroprene-type polymer obtained through radical polymerization of chloroprene or chloroprene and a radically-polymerizable monomer copolymerizable with chloroprene, in the presence of an acid functional group-having thiol compound represented by the following formula (2), an acid functional group-having disulfide compound represented by the following formula (3), or an acid functional group-having thiol compound represented by the following formula (2) and an acid functional group-having disulfide compound represented by the following formula (3):

H—S—R—X (2)

(wherein X represents a carboxyl group or its salt; R represents an alkyl group, an aryl group, a substituted alkyl group or a substituted aryl group),

X—R—S—S—R—X (3)

(wherein X represents a carboxyl group or its salt; R represents an alkyl group, an aryl group, a substituted alkyl group or a substituted aryl group).

3) The polychloroprene-base latex according to the above 1) or 2), wherein the number average molecular weight of the acid functional group-terminated polychloroprene-type polymer, as determined through gel permeation chromatography (GPC), is from 500 to 30,000.

4) A method for producing a polychloroprene-base latex according to any of the above 1) to 3), which comprises emulsifying chloroprene in water in the presence of a hydrophilic solvent by the use of an acid functional group-terminated polychloroprene-type polymer represented by the following formula (1) therein, and subjecting it to emulsion polymerization with a radical initiator added thereto:

polychloroprene-type polymer)-S—R—X (1)

5) The method for producing a polychloroprene-base latex according to the above 4), wherein the hydrophilic solvent is at least one solvent selected from acetone, methyl ethyl ketone, methoxyethanol, tetrahydrofuran, isopropanol, ethanol.

6) A polychloroprene-base latex comprising 2% or less by weight of a conventional emulsifier, and a polychloroprene-base random copolymer with hydrophilic group.

7) The polychloroprene-base latex according to the above 6), wherein the polychloroprene-base random copolymer with hydrophilic group is a random copolymer obtained through polymerization of chloroprene or chloroprene and a radically-polymerizable monomer copolymerizable with chloroprene, with a radically-polymerizable monomer with hydrophilic group.

8) The polychloroprene-base latex according to the above 7), wherein the radically-polymerizable monomer with hydrophilic group is a monomer selected from maleic acid, maleic anhydride, maleate, citraconic anhydride, fumaric acid, fumarate, methacrylic acid, acrylic acid, styrenesulfonic acid, vinylbenzoic acid, vinylacetic acid.

9) The polychloroprene-base latex according to any of the above 6) to 8), wherein the number average molecular weight of the polychloroprene-base random copolymer with hydrophilic group, as determined through gel permeation chromatography (GPC), is 100,000 or less.

10) A method for producing a polychloroprene-base latex according to any of the above 6) to 9), which comprises using a polychloroprene-base random copolymer with hydrophilic group in producing a polychloroprene-base latex through emulsion polymerization of chloroprene or chloroprene and a monomer copolymerizable with chloroprene.

11) The method for producing a polychloroprene-base latex according to the above 10), wherein the polychloroprene-base random copolymer with hydrophilic group is a random copolymer obtained through polymerization of chloroprene or chloroprene and a radically-polymerizable monomer copolymerizable with chloroprene, with a radically-polymerizable monomer with hydrophilic group.

12) An adhesive, a primer, a sealant, a binder and a coating agent, comprising a polychloroprene-base latex according to any of the above 1) to 3) and the above 6) to 9).

### DETAILED DESCRIPTION OF THE INVENTION

The invention is described in detail hereinafter.

The CR-base latex of the invention does not contain a conventional emulsifier used in conventional latex, or may contain it but its content is greatly reduced. The content of a conventional emulsifier in the CR-base latex of the invention is greatly reduced, and it means that the CR-base latex of the invention contains 2% or less by weight of a conventional emulsifier. When the content is more than 2% by weight, then the adhesiveness and the water resistance of the CR-base latex may remarkably lower. The conventional emulsifier includes anionic emulsifiers, nonionic emulsifiers and cationic emulsifiers conventionally used in the art; and for example, the anionic emulsifiers include rosinates, higher fatty acid salts, alkenylsuccinic acid salts, sodium alkylsulfates, higher alcohol sulfate sodium salts, alkylbenzenesulfonic acid salts, alkyldiphenyl ether disulfonic acid salts, sulfonic acid salts of higher fatty acid amides, sulfate salts of higher fatty acid alkylolamides, alkylsulfobetaines; the nonionic emulsifiers include polyoxyethylene alkyl ethers, polyoxyethylene sorbitan fatty acid esters, higher fatty acid alkanolamides, polyvinyl alcohol; and the cationic emulsifiers include alkylamine salts, quaternary ammonium salts.

The CR-base latex of the invention contains an acid group-terminated CR of the following formula (1), or a CR random copolymer with hydrophilic group. Containing the acid group-terminated CR or the CR random copolymer with hydrophilic group, the CR-base latex of the invention does not contain a conventional emulsifier, or may contain it but its content may be greatly reduced. The content of the acid group-terminated CR or the CR random copolymer hydrophilic group in the CR-base latex is not specifically defined; but for the purpose of not detracting from the adhesive strength and the water resistance of the latex, the content is preferably such that the content of the acid group derived from the acid group-terminated CR or the CR random copolymer hydrophilic group could be 10% or less by weight, more preferably 5% or less by weight.

(polychloroprene-type polymer)-S—R—X (1)

(wherein X represents a carboxyl group or its salt; R represents an alkyl group, an aryl group, a substituted alkyl group or a substituted aryl group).

First described are the acid group-terminated CR, and a method for producing a CR-base latex through emulsion polymerization using it.

The acid group-terminated CR is a polymer which has a sufficient potency of emulsifying chloroprene or chloroprene and a monomer copolymerizable with chloroprene in water and stabilizing the latex particles formed through polymerization of those monomers, in water. Specifically, the acid group-terminated CR is a CR-type polymer having an acid group such as a sulfonic acid group, a carboxyl group, a phosphoric acid group or their salt group, as introduced into the terminal of the CR skeleton thereof consisting essentially of chloroprene, therefore capable of forming micelles in water for monomer emulsification.

The acid group-terminated CR is a polymer obtained through radical polymerization of a radically polymerizable monomer consisting essentially of chloroprene, in the presence of an acid group-having thiol compound represented by the following formula (2), an acid group-having disulfide compound represented by the following formula (3), or an acid group—having thiol compound represented by the following formula (2) and an acid group-having disulfide compound represented by the following formula (3), in which the acid group is preferably a carboxyl group in view of the solubility in polymerization solvent, the cost and the availability of the compounds:

H—S—R—X (2)

(wherein X represents a carboxyl group or its salt; R represents an alkyl group, an aryl group, a substituted alkyl group or a substituted aryl group),

X—R—S—S—R—X (3)

(wherein X represents a carboxyl group or its salt; R represents an alkyl group, an aryl group, a substituted alkyl group or a substituted aryl group).

The acid group-having thiol compound includes thioglycolic acid, thiomalic acid, 2-mercaptopropionic acid, 3-mercaptopropionic acid, thiosalicylic acid, 3-mercaptobenzoic acid, 4-mercaptobenzoic acid, thiomalonic acid, thiosuccinic acid, thiomaleic acid, thiomaleic anhydride, dithiomaleic acid, thioglutaric acid, cysteine, homocysteine, 5-mercaptotetrazole-acetic acid, 3-mercapto-1-propanesulfonic acid; and the acid group-having disulfide compound includes 2,2′-dithiodipropionic acid, 3,3′-dithiodipropionic acid, 4,4′-dithiodibutanoic acid, 2,2′-dithiobisbenzoic acid, 6,6′-dithiodinicotinic acid. Specifically, one characteristic feature of the invention is that the invention does not require a step of copolymerization of chloroprene and an acid functional group-terminated monomer.

The main ingredient of the acid-terminated CR used in place of a conventional ordinary emulsifier is chloroprene; but not detracting from the characteristics of CR and the effect thereof as an emulsifier, it may be copolymerized with a monomer copolymerizable with chloroprene. The monomer copolymerizable with chloroprene includes 1,3-butadienes such as 2,3-dichloro-1,3-butadiene, 2-cyano-1,3-butadiene, 1-chloro-1,3-butadiene, 1,3-butadiene, isoprene; styrenes such as styrene, α-methylstyrene, p-chloromethylstyrene, p-cyanostyrene, p-acetoxystyrene, p-styrenesulfonyl chloride, p-styrenesulfonyl ethoxide, p-butoxystyrene, 4-vinylbenzoic acid, 3-isopropenyl-α,α′-dimethylbenzyl isocyanate; methacrylates such as methyl methacrylate, glycidyl methacrylate, 2-hydroxyethyl methacrylate, 2-hydroxypropyl methacrylate, 4-hydroxybutyl methacrylate, 2-(dimethylamino)ethyl methacrylate, 2-(diethylamino)ethyl methacrylate, 3-(dimethylamino)propyl methacrylate, 2-(isocyanate)ethyl methacrylate, 2,4,6-tribromophenyl methacrylate, 2,2,3,3-tetrafluoropropyl methacrylate, 2,2,2-trifluoroethyl methacrylate, 2,2,3,3,3-pentafluoropropyl methacrylate, 2,2,3,4,4,4-hexafluorobutyl methacrylate; acrylates such as butyl acrylate, ethyl acrylate, 2-ethylhexyl acrylate, 2-ethoxyethyl acrylate, 2-butoxyethyl acrylate, cyclohexyl acrylate, 3-(trimethoxysilyl)propyl acrylate, 2,2,3,3-tetrafluoropropyl acrylate, 2,2,2-trifluoroethyl acrylate, 2,2,3,3,3-pentafluoropropyl acrylate, 2,2,3,4,4,4-hexafluorobutyl acrylate; and in addition, acrylonitrile, methacrylonitrile, α-cyanoethyl acrylate, maleic anhydride, maleic acid, citraconic anhydride, vinylacetic acid, maleates, fumarates, crotonic acid, itaconic acid, fumaric acid, mono-2-(methacryloyloxy)ethyl phthalate, mono-2-(methacryloyloxy)ethyl succinate, mono-2-(acryloyloxy)ethyl succinate, methacrylic acid, acrylic acid, acrolein, diacetonacrylamide, vinyl methyl ketone, vinyl ethyl ketone, diacetone methacrylate. Of those, preferred are 2,3-dichloro-1,3-butadiene, 2-cyano-1,3-butadiene, 1-chloro-1,3-butadiene, styrene, methyl methacrylate, methacrylic acid, glycidyl methacrylate, 2-hydroxyethyl methacrylate, 2-hydroxypropyl methacrylate, 4-hydroxybutyl methacrylate, α-cyanoethyl acrylate, maleic anhydride and maleic acid, as their radical copolymerizability with chloroprene is relatively high. More preferred is 2,3-dichloro-1,3-butadiene that has the highest copolymerizability with chloroprene.

The above acid group-terminated CR may have one or two acid groups at the terminal of the polymer, depending on the type of the thiol compound or the disulfide compound used. Not specifically defined, the number average molecular weight, as measured through gel permeation chromatography (GPC), of the acid group-terminated CR is preferably from 500 to 30,000 for maintaining its micelle-forming ability and for preventing the latex viscosity from increasing.

For its production method, the acid group-terminated CR may be produced according to conventional radical polymerization. Specifically, chloroprene is radically polymerized in the presence of a radical initiator such as peroxides or azo compound, and a molecular weight-controlling agent (chain transfer agent) such as thiol compound or disulfide compound, in a suitable solvent or in the absence of a solvent. In this step, when an acid group-having thiol compound or an acid group-having disulfide compound is used, then an acid group-terminated CR may be produced through chain transfer reaction of chloroprene radical to these. In the method of producing a functional group (including acid group)-terminated polymer by utilizing the chain transfer reaction to the above compound, the monomer polymerization is re-initiated by the functional group-having sulfur radical formed through chain transfer of the growing radical or the initiator radical to the functional group-having thiol compound or the functional group-having disulfide compound, whereby the thiol compound-derived functional group is introduced into the polymer terminal. This method is described in High-Tech Polymer Material Series 1, High-Performance Liquid Polymer Material (issued by Maruzen, 1990, pages 13 and 32).

The radical initiator includes peroxide compounds such as benzoyl peroxide, lauroyl peroxide, t-butyl hydroperoxide, paramenthane hydroperoxide, dicumyl peroxide, cyclohexane peroxide, succinic acid peroxide, potassium persulfate, ammonium persulfate, hydrogen peroxide; and azo compounds such as 2,2′-azobis(4-methoxy-2,4-dimethylvaleronitrile), 2,2′-azobis(2,4-dimethylvaleronitrile), 2,2′-azobis(2-methylpropionitrile), 2,2′-azobis(2-methylbutyronitrile), 1,1′-azobis(cyclohexane-1-carbonitrile), 1-[(1-cyano-1-methylethyl)azo]formamide, dimethyl 2,2′-azobis(2-methylpropionate), 4,4′-azobis(4-cyanovaleric acid), 2,2′-azobis(2,4,4-trimethylpentane), 2,2′-azobis{2-methyl-N-[1,11-bis(hydroxymethyl)-2-hydroxye thyl]propionamide}, 2,2′-azobis{2-(2-imidazolin-2-yl)propane]dihydrochloride, 2,2′-azobis{2-(2-imidazolin-2-yl)propane]disulfate dihydrate, 2,2′-azobis{2-[1-(2-hydroxyethyl)-2-imidazolin-2-yl)propan e]}dihydrochloride, 2,2′-azobis(1-imino-1-pyrrolidino-2-methylpropane) dihydrochloride, 2,2′-azobis(2-methylpropionamidine) dihydrochloride, 2,2′-azobis[N-(2-carboxyethyl)-2-methylpropionamidine]tetrahydrate. For the purpose of increasing the terminal functionality of the acid group-terminated CR (acid functional group introduction percentage), preferred is use of the acid group-having initiator such as 4,4′-azobis(4-cyanovaleric acid), cyclohexane peroxide, succinic acid peroxide.

The solvent in producing the above acid group-terminated CR may be suitably selected from ethers such as tetrahydrofuran, dioxane, dimethoxyethane; ketones such as methyl ethyl ketone, methyl isobutyl ketone, acetone; aromatics such as toluene, benzene, chlorobenzene; halogenohydrocarbons such as dichloromethane, 1,1,2-trichloroethane, dichloroethane; alcohols such as isopropanol, ethanol, methanol, methoxyethanol; ethyl acetate and water, depending on the solubility of the above-mentioned thiol compound and disulfide compound therein. In case where the compounds are soluble in chloroprenes, then the solvent may be absent. However, preferred is use of a hydrophilic solvent such as acetone, methyl ethyl ketone, methoxyethanol, tetrahydrofuran, isopropanol or ethanol, from the viewpoint that the acid group-terminated CR may be used continuously in the emulsion polymerization step, not isolated from the polymerization system.

The CR-base latex of the invention is characterized in that an acid group-terminated CR is used in producing the CR-base latex through emulsion polymerization of chloroprene or chloroprene and a monomer copolymerizable with chloroprene. One characteristic feature of the method where the acid group-terminated CR is used is that the method does not require a step of copolymerization of chloroprene and an acid functional group-having monomer and, after the acid group-terminated CR has been produced, it may be directly processed in the emulsion polymerization step as it is (that is, in-situ emulsion polymerization). As an important point in this, the present inventors have found that, in the emulsion polymerization, the coexistence of a suitable amount of a hydrophilic solvent may promote micelle formation, therefore greatly improving the polymerization rate and the latex stability. In other words, in the absence of a suitable amount of a hydrophilic solvent, the fine micelle formation is insufficient, the polymerization rate is slow and the scale generation during polymerization increases.

Not specifically defined, the amount of the acid group-having CR to be used in emulsion polymerization may be such that the monomer could be sufficiently emulsified and the stability of the formed latex could be fully maintained; but in consideration of the latex viscosity increase and the mean molecular weight of the formed latex polymer, the amount is preferably 30% or less by weight of the overall monomer amount; and in consideration of the adhesive strength and the water resistance of the latex, it is more preferably 20% or less by weight.

The method of emulsion polymerization of chloroprene or chloroprene and a monomer copolymerizable with it in producing the CR-base latex of the invention may be the same as that of conventional emulsion polymerization except that an acid group-terminated CR and a hydrophilic solvent are used.

An example of a process that comprises a series of producing an acid group-terminated CR and producing a CR-base latex by the use of the acid group-terminated CR is described below.

First, in a solvent such as tetrahydrofuran, dioxane, dimethoxyethane, methyl ethyl ketone, methyl isobutyl ketone, acetone, toluene, benzene, chlorobenzene, dichloromethane, 1,1,2-trichloroethane, dichloroethane, isopropanol, ethanol, methanol, methoxyethanol, water, or in the absence of a solvent, chloroprene or the like is radically polymerized in the presence of the above-mentioned acid group-having thiol compound or acid group-having disulfide compound, to thereby produce a polymer solution of an acid group-terminated CR. To the polymer solution, added is a basic compound such as triethylamine, diethylamine, triethanolamine, diethanolamine, ethanolamine, propanolamine, N,N-dimethylethanolamine, N,N-diethylethanolamine, morpholine, N-methylmorpholine, piperazine, 2-amino-2-methyl-1-propanol, 2-dimethylamino-2-methyl-1-propanol, N-methyldiethanolamine, N-ethyldiethanolamine, monoisopropanolamine, ammonia, sodium hydroxide, potassium hydroxide, thereby to neutralize it; and water is added thereto and stirred for micelle formation, and then (or this is neutralized by addition of a basic compound thereto, and then poured into water with stirring for micelle formation, and then), chloroprene and optionally a monomer copolymerizable with chloroprene and also a molecular weight-controlling agent are added thereto to prepare a monomer emulsion. Alternatively, after a basic compound is added to the above polymer solution and the monomer mixture, water is added to prepare a monomer emulsion. Still alternatively, an acid group-terminated CR, a basic compound, a molecular weight-controlling agent and a monomer mixture may be added to water. In the above emulsion polymerization, it is desirable that a suitable amount of a hydrophilic solvent is present in the system from the viewpoint of the polymerization rate and the latex stability.

As the hydrophilic solvent, usable are tetrahydrofuran, dioxane, dimethoxyethane, methyl ethyl ketone, methyl isobutyl ketone, acetone, isopropanol, ethanol, methoxyethanol, butyl cellosolve, ethyl cellosolve, ethyl acetate. Not specifically defined, the amount of the hydrophilic solvent to be added is preferably from 5 to 50% by weight of the sum total of the monomers such as acid group-terminated CR and chloroprene, more preferably from 5 to 20% by weight, for maintaining the effect of promoting micelle formation and for cohesion of latex particles.

As the basic compound, more preferred are alkylamine, alkanolamine and ammonia, in consideration of the micelle formation and the adhesiveness and the water resistance of the CR latex. A radical initiator and optionally a reducing agent are added to the above monomer emulsion to attain polymerization. For maintaining the CR stability by controlling the formation of 1,2- and 3,4-bonding in CR, the polymerization temperature is preferably not higher than 70° C. For more ensuring the CR stability, it is preferably not higher than 60° C. When the intended monomer conversion is attained, a polymerization inhibitor is added to stop the polymerization. Next, the unreacted monomer and the hydrophilic solvent are evaporated away under reduced pressure, thereby giving a CR-base latex. For the purpose of improving the stability of latex, reducing the viscosity thereof and reducing the surface tension thereof during or after polymerization, any ordinary emulsifier and dispersant may be added. However, the amount of the emulsifier and the dispersant should be 2% or less by weight of the CR-type polymer. When the amount is more than 2% by weight, then the adhesiveness and the water resistance of the CR latex may noticeably lower. For inhibiting the reduction in the adhesiveness and the water resistance by the emulsifier and the dispersant, it is more desirable that the emulsifier and the dispersant to be contained in the latex account for 1% or less by weight.

As the molecular weight-controlling agent, usable are mercaptans such as n-dodecylmercaptan, octylmercaptan, t-butylmercaptan, thioglycolic acid, thiomalic acid, thiosalicylic acid; sulfides such as diisopropylxanthogene disulfide, diethylxanthogene disulfide, diethylthiuram disulfide; halogenohydrocarbons such as iodoform; diphenylethylene, p-chlorodiphenylethylene, p-cyanodiphenylethylene, α-methylstyrene dimer, sulfur. As the radical initiator, usable are peroxides such as benzoyl peroxide, lauroyl peroxide, t-butyl hydroperoxide, paramenthane hydroperoxide, dicumyl peroxide, potassium persulfate, ammonium persulfate; and azo compounds such as 2,2′-azobis(4-methoxy-2,4-dimethylvaleronitrile), 2,2′-azobis(2,4-dimethylvaleronitrile), 2,2′-azobis(2-methylpropionitrile), 2,2′-azobis(2-methylbutyronitrile), 1,1′-azobis(cyclohexane-1-carbonitrile), 1-[(1-cyano-1-methylethyl)azo]formamide, dimethyl 2,2′-azobis(2-methylpropionate),4,4′-azobis(4-cyanovaleric acid), 2,2′-azobis(2,4,4-trimethylpentane), 2,2′-azobis{2-methyl-N-[1,1′-bis(hydroxymethyl)-2-hydroxye thyl]propionamide}, 2,2′-azobis{2-(2-imidazolin-2-yl)propane}dihydrochloride, 2,2′-azobis{2-(2-imidazolin-2-yl)propane}disulfate dihydrate, 2,2′-azobis{2-[1-(2-hydroxyethyl)-2-imidazolin-2-yl]propan e}}dihydrochloride, 2,2′-azobis(1-imino-1-pyrrolidino-2-methylpropane) dihydrochloride, 2,2′-azobis(2-methylpropionamidine) dihydrochloride, 2,2′-azobis[N-(2-carboxyethyl)-2-methylpropionamidine]tetrahydrate. As the reducing agent for promoting the decomposition of peroxide, usable are hydrosulfite, Rongalite, sodium sulfite, sodium thiosulfate, ferrous sulfate, ascorbic acid, aniline. As the polymerization initiator, usable are phenothiazine, 2,6-di-6-butyl-4-methylphenol, 2,2′-methylenebis(4-ethyl-6-t-butylphenol), tris(nonylphenyl)phosphite, 4,4′-thiobis(3-methyl-6-t-butylphenol), N-phenyl-1-naphthylamine, 2,2′-methylenebis(4-methyl-6-t-butylphenol), 2-mercaptobenzimidazole, hydroquinone, N,N-diethylhydroxylamine.

Next described are a CR random copolymer with hydrophilic group and a method for producing a CR-base latex through emulsion polymerization using it.

A CR random copolymer with hydrophilic group is a CR-base copolymer having a structure where a hydrophilic group is randomly distributed in the main chain thereof, and is obtained by introducing a hydrophilic group into a CR skeleton consisting essentially of chloroprene to thereby form a micelle in water, and then emulsifying the monomer; and like the acid group-terminated CR, this may be used in place of a conventional ordinary emulsifier. The CR random copolymer with hydrophilic group has a sufficient potency of emulsifying chloroprene or chloroprene and a monomer copolymerizable with chloroprene in water and stabilizing the latex particles formed through polymerization of those monomers, in water. For example, it includes chloroprene/maleic anhydride random copolymer, chloroprene/maleic acid random copolymer, chloroprene/citraconic anhydride random copolymer, chloroprene/methacrylic acid random copolymer, chloroprene/vinylacetic acid random copolymer, chloroprene/p-acetoxystyrene random copolymer, chloroprene/vinylbenzoic acid random copolymer, chloroprene/2,3-dichloro-1,3-butadiene/maleic anhydride random copolymer, chloroprene/ethyl p-styrenesulfonate random copolymer, chloroprene/styrenesulfonic acid random copolymer.

Not specifically defined, the hydrophilic group that the hydrophilic group-having CR random copolymer has may be any water-soluble group, including, for example, an acid functional group (sulfonic acid group, carboxyl group, phosphoric acid group and their salts), a hydroxyl group, a polyalkylene oxide, an amino group, and a quaternary ammonium group. Of those, more preferred is an acid functional group, as capable of forming micelles in water in a smaller amount to impart monomer-emulsifying characteristics to CR. The content of the hydrophilic group in the hydrophilic group-having CR random copolymer is not specifically defined; however, for obtaining a sufficient monomer emulsifying power and for maintaining water resistance, it is preferably from 1 to 40% by weight, more preferably from 1 to 20% by weight.

Not specifically defined, the number average molecular weight of the CR random copolymer with hydrophilic group, as determined through gel permeation chromatography (GPC), is preferably 100,000 or less, more preferably from 1,000 to 60,000, for the purpose of maintaining the micelle-forming ability and for preventing the increase in the latex viscosity.

The main ingredient of the CR random copolymer with hydrophilic group that is used in place of an ordinary conventional emulsifier is chloroprene, but the copolymer may be copolymerized with a monomer copolymerizable with chloroprene, not detracting from the characteristics of CR. The monomer copolymerizable with chloroprene includes 1,3-butadienes such as 2,3-dichloro-1,3-butadiene, 2-cyano-1,3-butadiene, 1-chloro-1,3-butadiene; styrenes such as styrene, α-methylstyrene, p-chloromethylstyrene, p-cyanostyrene, p-acetoxystyrene, p-styrenesulfonyl chloride, p-styrenesulfonyl ethoxide, p-butoxystyrene, 4-vinylbenzoic acid, 3-isopropenyl-α,α′-dimethylbenzyl isocyanate; methacrylates such as methyl methacrylate, glycidyl methacrylate, 2-hydroxyethyl methacrylate, 2-hydroxypropyl methacrylate, 4-hydroxybutyl methacrylate, 2-(dimethylamino)ethyl methacrylate, 2-(diethylamino)ethyl methacrylate, 3-(dimethylamino)propyl methacrylate, 2-(isocyanate)ethyl methacrylate, 2,4,6-tribromophenyl methacrylate, 2,2,3,3-tetrafluoropropyl methacrylate, 2,2,2-trifluoroethyl methacrylate, 2,2,3,3,3-pentafluoropropyl methacrylate, 2,2,3,4,4,4-hexafluorobutyl methacrylate; acrylates such as butyl acrylate, ethyl acrylate, 2-ethylhexyl acrylate, 2-ethoxyethyl acrylate, 2-butoxyethyl acrylate, cyclohexyl acrylate, 3-(trimethoxysilyl)propyl acrylate, 2,2,3,3-tetrafluoropropyl acrylate, 2,2,2-trifluoroethyl acrylate, 2,2,3,3,3-pentafluoropropyl acrylate, 2,2,3,4,4,4-hexafluorobutyl acrylate; and in addition, acrylonitrile, methacrylonitrile, α-cyanoethyl acrylate, maleic anhydride, methacrylic acid, acrylic acid, acrolein, diacetonacrylamide, vinyl methyl ketone, diacetone methacrylate. Of those, preferred are 2,3-dichloro-1,3-butadiene, 2-cyano-1,3-butadiene, 1-chloro-1,3-butadiene, styrene, methyl methacrylate, methacrylic acid, glycidyl methacrylate, 2-hydroxyethyl methacrylate, 2-hydroxypropyl methacrylate, 4-hydroxybutyl methacrylate and α-cyanoethyl acrylate, as their radical copolymerizability with chloroprene is relatively high. More preferred is 2,3-dichloro-1,3-butadiene that has the highest copolymerizability with chloroprene.

The radically polymerizable monomer with hydrophilic group for use in producing the above-mentioned CR random copolymer with hydrophilic group includes, for example, as a sulfonic acid group-having monomer, styrenesulfonic acid, 4-(methacryloyloxy)butylsulfonic acid, methallylsulfonic acid, vinylsulfonyl acid, and their salts; as a phosphoric acid group-having monomer, 2-(methacryloyloxy)ethyl phosphate and its salts; as a carboxyl group-having monomer, methacrylic acid, acrylic acid, vinylbenzoic acid, vinylacetic acid, maleic anhydride, maleic acid, maleates, fumarates, crotonic acid, itaconic acid, fumaric acid, citraconic anhydride, mono-2-(methacryloyloxy)ethyl phthalate, mono-2-(methacryloyloxy)ethyl succinate, mono-2-(acryloyloxy)ethyl succinate, and their salts; as a hydroxyl group-having monomer, 2-hydroxyethyl methacrylate, 2-hydroxyethyl acrylate, 2-hydroxypropyl methacrylate, 2-hydroxypropyl acrylate, 4-hydroxybutyl methacrylate, 4-hydroxybutyl acrylate; as a polyalkylene oxide-having monomer, polyethylene glycol methacrylate, polyethylene glycol acrylate; as an amino group-having monomer, dimethylaminoethyl methacrylate, dimethylaminoethyl acrylate, diethylaminoethyl methacrylate, diethylaminoethyl acrylate; and as a quaternary ammonium salt-having monomer, [(2-methacryloyloxy)ethyl]trimethylammonium chloride, [(2-acryloyloxy)ethyl]trimethyl ammonium chloride. Of those, preferred are monomers selected from maleic acid, maleic anhydride, maleates, citraconic anhydride, fumaric acid, fumarates, methacrylic acid, acrylic acid, styrenesulfonic acid, vinylbenzoic acid, vinylacetic acid, as their solubility in organic solvent and their copolymerizability with chloroprene are relatively high. The monomer having a functional group capable of being converted into a hydrophilic group for use in producing the above-mentioned CR random copolymer with hydrophilic group includes, for example, as a monomer having a functional group convertible into a sulfonic acid, alkyl p-styrenesulfonates, p-chlorosulfonylstyrene; as a monomer having a functional group convertible into a carboxyl group, t-butyl methacrylate, t-butyl acrylate, benzyl methacrylate, benzyl acrylate; and as a monomer having a functional group convertible into a hydroxyl group, glycidyl methacrylate, glycidyl acrylate.

In case where the CR-base latex of the invention is used for applications to adhesives, primers and sealants that require water resistance to external moisture, preferably utilized is, of the above-mentioned hydrophilic group, an acid group such as a sulfonic acid group, a phosphoric acid group, a carboxylic acid group, or a functional group convertible into such an acid group that may express latex stability even in a smaller amount of the hydrophilic group content. Further, in consideration of the solubility in polymerization solvent of the above-mentioned hydrophilic group-having monomer, radical initiator and chain transfer agent, preferred is use of a carboxyl group-having monomer, a radical initiator and a chain transfer agent; and in consideration of the cost thereof, the monomer is more preferably maleic anhydride, citraconic anhydride, maleic acid, maleic monoesters, vinylacetic acid, methacrylic acid, acrylic acid; the initiator is more preferably 4,4′-azobis(4-cyanopentanoic acid); and the chain transfer agent is more preferably thiomalic acid.

The CR-base latex of the invention is usable in applications to binders for electrodes for secondary batteries and capacitors. In case where it is used in a closed system shielded from the outside, like in those, or that is, when the latex is kept away from contact with external moisture, then the monomer having a hydroxyl group, alkylene oxide or amino group may be a monomer having a functional group capable of being converted into a hydroxyl group or an amino group. In addition to the above, the latex may also be utilized for dipping for gloves, yarn rubber; for gumming for balloons, rubber boats; as well as for toner binders, fiber processors.

For producing the CR random copolymer with hydrophilic group, herein employable are a method of radical copolymerization of chloroprene or the like with a hydrophilic group-having monomer or with a monomer having a functional group convertible into a hydrophilic group; a method of graft-polymerizing a hydrophilic monomer into CR by the use of an organic peroxide such as benzoyl peroxide in an organic solvent; and a method of radical copolymerization of a reactive emulsifier and chloroprene. As a method capable of controlling the amount of the hydrophilic group to be introduced into a CR skeleton in a simplified manner, preferred is the method of radical copolymerization of chloroprene or the like with a hydrophilic group-having monomer or with a monomer having a functional group capable of being converted into a hydrophilic group. The radical copolymerization method as referred to herein is a conventional traditional radical polymerization method, which is for radical copolymerization of chloroprene or the like with a hydrophilic group-having monomer or with a monomer having a functional group capable of being converted into a hydrophilic group, in the presence of a radical initiator and a molecular weight-controlling agent in a solvent or in the absence of a solvent.

The radical initiator includes peroxide compounds such as benzoyl peroxide, lauroyl peroxide, t-butyl hydroperoxide, paramenthane hydroperoxide, dicumyl peroxide, hydrogen peroxide, potassium persulfate, ammonium persulfate; and azo compounds such as 2,2′-azobis(4-methoxy-2,4-dimethylvaleronitrile), 2,21-azobis(2,4-dimethylvaleronitrile), 2,21-azobis(2-methylpropionitrile), 2,2′-azobis(2-methylbutyronitrile), 1,1′-azobis(cyclohexane-1-carbonitrile), 1-[(1-cyano-1-methylethyl)azo]formamide, dimethyl 2,2′-azobis(2-methylpropionate),4,4′-azobis(4-cyanovaleric acid), 2,2′-azobis(2,4,4-trimethylpentane), 2,2′-azobis{2-methyl-N-[1,1′-bis(hydroxymethyl)-2-hydroxye thyl]propionamide}, 2,2′-azobis{2-(2-imidazolin-2-yl)propane}dihydrochloride, 2,2′-azobis{2-(2-imidazolin-2-yl)propane}disulfate dihydrate, 2,2′-azobis{2-[1-(2-hydroxyethyl)-2-imidazolin-2-yl]propan e}}dihydrochloride, 2,2′-azobis(1-imino-1-pyrrolidino-2-methylpropane) dihydrochloride, 2,2′-azobis(2-methylpropionamidine) dihydrochloride, 2,21-azobis[N-(2-carboxyethyl)-2-methylpropionamidine]tetrahydrate.

As the molecular weight-controlling agent, usable are disulfides such as diisopropylxanthogene disulfide, diethylxanthogene disulfide, diethylthiuram disulfide, 2,2′-dithiodipropionic acid, 3,3′-dithiodipropionic acid, 4,4′-dithiodibutanoic acid, 2,2′-dithiobisbenzoic acid; mercaptans such as n-dodecylmercaptan, octylmercaptan, t-butylmercaptan, thioglycolic acid, thiomalic acid, 2-mercaptopropionic acid, 3-mercaptopropionic acid, thiosalicylic acid, 3-mercaptobenzoic acid, 4-mercaptobenzoic acid, thiomalonic acid, dithiosuccinic acid, thiomaleic acid, thiomaleic anhydride, dithiomaleic acid, thioglutaric acid, cysteine, homocysteine, 3-mercaptotetrazole-acetic acid, 3-mercapto-1-propanesulfonic acid; halogenohydrocarbons such as iodoform; and diphenylethylene, p-chlorodiphenylethylene, p-cyanodiphenylethylene, α-methylstyrene dimer, sulfur. Especially preferred are disulfides such as xanthogene disulfide, and carboxyl group-having mercaptans such as thioglycolic acid, thiomalic acid and thiosalicylic acid, from the viewpoint of more excellent latex stability.

The CR-base latex of the invention is characterized in that a CR random copolymer with hydrophilic group is used in producing the CR-base latex through emulsion polymerization of chloroprene or chloroprene and a monomer copolymerizable with chloroprene. In particular, for stably emulsifying the monomer such as chloroprene in water and for obtaining a stable latex, it is desirable to use a copolymer of a monomer consisting essentially of chloroprene and a radically polymerizable monomer with hydrophilic group.

The CR random copolymer with hydrophilic group is the same as that described hereinabove.

The amount of the CR random copolymer with hydrophilic group to be used in emulsion polymerization is not specifically defined so far as the monomer may be sufficiently emulsified and sufficient stability of the formed latex may be maintained; however, in consideration of the latex viscosity increase, the amount is preferably 30% or less by weight of the overall monomer amount; and in consideration of the adhesiveness and the water resistance of the latex to be obtained finally, the amount is more preferably 20% or less by weight.

The method of emulsion polymerization of chloroprene or chloroprene and a monomer copolymerizable with it in producing the CR-base latex of the invention may be the same as that of conventional emulsion polymerization except that a CR random copolymer with hydrophilic group is used.

An example of a process that comprises a series of producing a CR random copolymer with hydrophilic group and producing a CR-base latex by the use of the CR random copolymer with hydrophilic group is described below.

First, in a hydrophilic solvent such as tetrahydrofuran, dioxane, acetone, isopropyl alcohol, ethanol, butyl cellosolve, methoxyethanol, methyl ethyl ketone, ethyl acetate, or in the absence of a solvent, chloroprene is radically copolymerized a hydrophilic group-having monomer in the presence of a molecular weight-controlling agent such as xanthogene disulfide, thiuram disulfide, mercaptan, thereby producing a CR random copolymer with hydrophilic group. In case where the hydrophilic group is an acid group, the polymer solution is put into an aqueous solution of a basic compound such as triethylamine, diethylamine, triethanolamine, diethanolamine, ethanolamine, propanolamine, N,N-dimethylethanolamine, morpholine, N-methylmorpholine, 2-amino-2-methyl-1-propanol, ammonia, sodium hydroxide, potassium hydroxide, or such a basic compound is added to the polymer solution, and then water is added thereto, thereby preparing an aqueous solution of the hydrophilic group-having CR random copolymer. As the basic compound, especially preferred are alkylamine, alkanolamine and ammonia, in consideration of the adhesiveness and the water resistance of the soapless CR-base latex. Into the above aqueous solution, put were a monomer such as chloroprene or the like and optionally a molecular weight-controlling agent such as mercaptan, and the monomer is emulsified; and then a radical initiator and optionally a reducing agent are added thereto to attain polymerization. After this, the process is the same as the emulsion polymerization method that uses an acid group-terminated CR.

The CR-base latex of the invention may be used as adhesives, primers, sealants, binders and coating agents, as combined with tackifier resin such as rosinate resin, terpene phenol resin, petroleum resin, chroman-indene resin; salt of alkylphenol resin, functional acid group-having resin (e.g., polymer rosin, rosin-modified maleic acid resin); inorganic filler such as silica, clay, aluminium paste, titanium oxide, zeolite, calcium carbonate, carbon; thickener such as hydrophobic cellulose, polycarboxylic acid salt, associated nonionic surfactant, polyalkylene oxide, clay; curing agent such as polyisocyanate compound, epoxy resin, oxazoline compound, carbodiimide compound, hydrazine derivative, silane compound; acid acceptor such as zinc oxide, hydrotalcite, epoxy resin; pH-controlling agent such as sodium hydroxide, potassium hydroxide, potassium carbonate, sodium carbonate, phosphoric acid; plasticizer, wetting agent, freezing inhibitor, film formation promoter, added thereto.

In the CR-base latex obtained in the invention, the amount of the emulsifier generally used in a large amount in conventional CR latex may be greatly reduced, and therefore, the invention enables production of CR latex-base adhesives, primers, coating agents and sealants having extremely improved adhesiveness and water resistance, and has other applications for dipping for gloves and yarn rubber, for gumming for balloons and rubber boats, for fiber processing, further enabling production of binders for electrodes for capacitors and secondary batteries, and binders for inks, toners, magnetic paints, etc.

### EXAMPLES

The following Examples are shown for more concretely describing the invention; however, the invention should not be limited to these Examples.

The number average molecular weight Mn, the weight average molecular weight Mw and the molecular weight distribution Mw/Mn of the polymer of the invention were determined, using GPC8220 (manufactured by TOSOH CORPORATION) according to the following condition: The eluent is tetrahydrofuran; the flow rate is 1.0 ml/min; the column temperature is 40° C.; the peak is detected with a differential refractiometer; the pack column is TSK-gel (registered trade name—the same shall apply hereinunder) G7000Hxl/GMHxl/GMHxl/G3000Hxl/guard column H-L; the molecular weight computation is in terms of polystyrene. The monomer conversion in polymerization is computed, using gas chromatogram GC-17A manufactured by SHIMADZU CORPORATION (with GL Science's capillary column NEUTRABOND-5, hydrogen flame ionization detector) and based on benzene as the standard substance.

The carboxyl group amount in the CR random copolymer with hydrophilic group was determined through neutralization titration with potassium hydroxide.

The chlorine amount in the CR random copolymer with hydrophilic group was determined according to oxygen flask combustion-ion chromatography under the following condition. 20 mg of a polymer sample is accurately weighed and taken up, fired according to a flask combustion method, and adsorbed by an adsorbent liquid comprising 10 ml of an aqueous solution of N/100 sodium hydroxide with 100 μl of aqueous 30% hydrogen peroxide added thereto. The adsorbent liquid was made up to 50 ml with pure water added thereto, and the chloride ion in the absorbent liquid was quantitatively determined through ion chromatography. The test condition in ion chromatography was as follows: Ion chromatograph manufactured by TOSOH CORPORATION, column: TSKgel IC-Anion-PWXL PEEK is used. The eluent is an aqueous solution comprising 1.3 mM potassium gluconate, 1.3 mM borax, 30 mM boric acid, 10 vol. % acetonitrile and 0.5 vol. % glycerin. The column temperature is 40° C. The flow rate is 1.2 ml/min. An electroconductivity detector is used.

The particle size of the CR-base latex was determined, using a laser diffraction/scattering particle sizer LA-920 (by HORIBA, Ltd.).

The mechanical stability of the CR-base latex was evaluated from the rubber deposition percentage according to a Maron test method.

The potency of the CR-base latex as adhesive was evaluated according to the following method. Using a brush, a CR-base latex is applied to two sheets of #9 cotton canvas, and dried in an oven at 80° C. for 5 minutes (the coating-drying cycle was repeated three times), and after an open time (left as such for a predetermined period of time) at room temperature, they are stuck together under pressure with a hand roller. After aged at room temperature for 3 days, this is cut into a strip having a width of 25 mm, and subjected to a 180-degree T-type peeling test under a condition of a pulling speed of 100 mm/min, using a Tensilon tensile tester. The adhesiveness is evaluated from the peeling strength and the peeling state change after the open time. Concretely, when the adhesiveness is sufficient, the peeling strength reduction is small even after a long open time; but when it is insufficient, the peeling at the adhesive interface (delamination) is noticeable and the peeling strength reduction increases. The water resistance is evaluated as follows: The two sheets are stuck together under pressure after an open time of 3 hours, and then aged at room temperature for 3 days. The test piece is dipped in pure water at room temperature for 3 days, and while wet, this is subjected to the 180-degree T-type peeling test under the same condition as above.

### Example 1

10.00 g of thioglycolic acid, 3.00 g of 4,4′-azobis(4-cyanopentanoic acid), 1.20 g of benzene and 50.00 g of tetrahydrofuran were put into a 500-ml brown glass flask equipped with a three-way cock, and dissolved, and then 120.50 g of chloroprene was added thereto, and this was fully pumped in two freeze-pump-thaw cycles, and then heated in an oil bath at 50° C. with stirring with a magnetic stirrer in a nitrogen atmosphere, thereby giving a tetrahydrofuran solution of an acid group-terminated CR (CR-base polymer/thioglycolic acid). After 65 hours, the polymerization conversion of chloroprene was 78.2%.

As determined through GPC, the number-average molecular weight Mn of the formed polymer was 2,100, and the weight-average molecular weight Mw thereof was 5,200.

Next, 20.20 g of the tetrahydrofuran solution of the acid group-terminated CR (CR-base polymer/thioglycolic acid) produced in the above, 0.13 g of n-dodecylmercaptan, 0.31 g of benzene, 1.72 g (1.2 equivalents relative to the carboxyl group contained in the above solution) of triethylamine, and 40.25 g of pure water were put into a 200-ml glass flask equipped with a three-way cock, and mixed, and then 45.29 g of chloroprene and 0.2 ml of aqueous 3.40% by weight potassium persulfate solution were added thereto (the amount of the carboxyl group-terminated CR added relative to the monomer was about 18.5% by weight). A nitrogen flow was applied to it for 30 minutes at a flow rate of 1 L/min for well pumping it, and heating it was started in an oil bath at 4° C. with stirring with a magnetic stirrer. This was polymerized for 9 hours with adding 0.2 ml of the above aqueous potassium persulfate solution thereto at intervals of 2 hours, and then 50 mg of phenothiazine was added to stop the polymerization. The chloroprene polymerization conversion was 89%, and no scale formed. The unreacted monomer, acetone and water were evaporated away with a rotary evaporator to obtain a CR-base latex-A (solid content, 47% by weight).

The Maron test deposition percentage of the CR-base latex-A was 0.010% by weight; and the mean particle size thereof was 112 nm; and the latex had extremely high stability. (The carboxyl group content relative to the polymer in the latex was about 1.24% by weight.)

The adhesiveness potency of the obtained CR-base latex-A was evaluated, and the result is shown in Table 1. As compared with the comparative CR-base latex, the peeling strength reduction after the open time and the peeling strength reduction after dipping in water of the latex-A were small, and it is obvious that, as compared with the conventional latex, the adhesiveness and the water resistance of the latex-A are extremely improved.

TABLE 1

| | | Example 1 | Example 2 | Example 3 | Example 4 | Example 5 | Example 6 | Example 7 | Example 8 |
|---|---|---|---|---|---|---|---|---|---|
| Formulation (wt. pt.) | | | | | | | | | |
| CR-base latex-A | | 100 | — | — | — | — | — | — | — |
| CR-base latex-B | | — | 100 | — | — | — | — | — | — |
| CR-base latex-C | | — | — | 100 | — | — | — | — | — |
| CR-base latex-D | | — | — | — | 100 | — | — | — | — |
| CR-base latex-E | | — | — | — | — | 100 | — | — | — |
| CR-base latex-F | | — | — | — | — | — | 100 | — | — |
| CR-base latex-G | | — | — | — | — | — | — | 100 | — |
| CR-base latex-H | | — | — | — | — | — | — | — | 100 |
| Ordinary Peeling Strength | | | | | | | | | |
| (N/25 mm)¹⁾ | | | | | | | | | |
| open time | 0.5 hrs | 71C | 75C | 75C | 72C | 69C | 69C | 59C | 71C |
| | 1 hr | 68C | 71C | 72C/S | 72C/S | 66C | 66C | 58C | 69C/S |
| | 2 hrs | 65C/S | 68C/S | 69C/S | 69C/S | 65C/S | 64C/S | 55C/S | 65C/S |

| | | | | | | | | |
|---|---|---|---|---|---|---|---|---|
| Water-Resistant Peeling | 60C | 62C | 65C | 60C | 62C | 62C | 55C | 65C |
| Strength (N/25 mm)¹⁾ | | | | | | | | |

¹⁾Peeling State: C = cohesive failure in the adhesive layer. S = peeling at the adhesive interface.

### Example 2

13.30 g of 2-mercaptopropionic acid, 2.60 g of 4,4′-azobis(4-cyanopentanoic acid), 1.95 g of benzene and 89.5 g of acetone were put into a 500-ml brown glass flask equipped with a three-way cock, and dissolved, and then 120.50 g of chloroprene was added thereto, and this was fully pumped in two freeze-pump-thaw cycles, and then heated in an oil bath at 50° C. with stirring with a magnetic stirrer in a nitrogen atmosphere, thereby giving an acetone solution of an acid group-terminated CR (CR-base polymer/2-mercaptopropionic acid). After 65 hours, the polymerization conversion of chloroprene was 80.3%.

As determined through GPC, the number-average molecular weight Mn of the formed polymer was 2,200, and the weight-average molecular weight Mw thereof was 4,900.

Next, 23.00 g of the acetone solution of the acid group-terminated CR (CR-base polymer/2-mercaptopropionic acid) produced in the above, 0.13 g of n-dodecylmercaptan, 0.31 g of benzene, 1.76 g (1.2 equivalents relative to the carboxyl group contained in the above solution) of triethylamine, and 40.25 g of pure water were put into a 200-ml glass flask equipped with a three-way cock, and mixed, and then 45.00 g of chloroprene and 0.2 ml of aqueous 3.40% by weight potassium persulfate solution were added thereto (the amount of the acid group-terminated CR added relative to the monomer was about 17.8% by weight). A nitrogen flow was applied to it for 30 minutes at a flow rate of 1 L/min for well pumping it, and heating it was started in an oil bath at 40° C. with stirring with a magnetic stirrer. This was polymerized for 9 hours with adding 0.2 ml of the above aqueous potassium persulfate solution thereto at intervals of 2 hours, and then 50 mg of phenothiazine was added to stop the polymerization. The chloroprene polymerization conversion was 89%, and no scale formed. The unreacted monomer, acetone and water were evaporated away with a rotary evaporator to obtain a CR-base latex-B (solid content, 47% by weight).

The Maron test deposition percentage of the CR-base latex-B was 0.0092% by weight; and the mean particle size thereof was 106 nm; and the latex had extremely high stability. (The carboxyl group content relative to the polymer in the latex was about 1.24% by weight.)

The adhesiveness potency of the obtained CR-base latex-B was evaluated, and the result is shown in Table 1. As compared with the comparative CR-base latex, the peeling strength reduction after the open time and the peeling strength reduction after dipping in water of the latex-B were small, and it is obvious that, as compared with the conventional latex, the adhesiveness and the water resistance of the latex-B are extremely improved.

### Example 3

6.50 g of thiomalic acid, 7.50 g of di(4-carboxybutyl) disulfide, 2.60 g of 4,4′-azobis(4-cyanopentanoic acid), 1.96 g of benzene and 89.2 g of acetone were put into a 500-ml brown glass flask equipped with a three-way cock, and dissolved, and then 120.50 g of chloroprene was added thereto, and this was fully pumped in two freeze-pump-thaw cycles, and then heated in an oil bath at 50° C. with stirring with a magnetic stirrer in a nitrogen atmosphere, thereby giving an acetone solution of an acid group-terminated CR (CR-base polymer/thiomalic acid). After 65 hours, the polymerization conversion of chloroprene was 79.6%.

As determined through GPC, the number-average molecular weight Mn of the formed polymer was 2,800, and the weight-average molecular weight Mw thereof was 5,800.

Next, 18.50 g of the acetone solution of the acid group-terminated CR (CR-base polymer/thiomalic acid) produced in the above, 0.14 g of n-dodecylmercaptan, 0.31 g of benzene, 1.65 g (1.2 equivalents relative to the carboxyl group contained in the above solution) of triethylamine, and 40.20 g of pure water were put into a 200-ml glass flask equipped with a three-way cock, and mixed, and then 39.50 g of chloroprene and 0.2 ml of aqueous 3.40% by weight potassium persulfate solution were added thereto (the amount of the acid group-terminated CR added relative to the monomer was about 16.4% by weight). A nitrogen flow was applied to it for 30 minutes at a flow rate of 1 L/min for well pumping it, and heating it was started in an oil bath at 40° C. with stirring with a magnetic stirrer. This was polymerized for 9 hours with adding 0.2 ml of the above aqueous potassium persulfate solution thereto at intervals of 2 hours, and then 50 mg of phenothiazine was added to stop the polymerization. The chloroprene polymerization conversion was 93.3%, and no scale formed. The unreacted monomer, acetone and water were evaporated away with a rotary evaporator to obtain a CR-base latex-C (solid content, 47% by weight).

The Maron test deposition percentage of the CR-base latex-C was 0.0064% by weight; and the mean particle size thereof was 105 nm; and the latex had extremely high stability. (The carboxyl group content relative to the polymer in the latex was about 1.35% by weight.)

The adhesiveness potency of the obtained CR-base latex-C was evaluated, and the result is shown in Table 1. As compared with the comparative CR-base latex, the peeling strength reduction after the open time and the peeling strength reduction after dipping in water of the latex-C were small, and it is obvious that, as compared with the conventional latex, the adhesiveness and the water resistance of the latex-C are extremely improved.

### Example 4

10.34 g of thiomalic acid, 2.65 g of 4,4′-azobis(4-cyanopentanoic acid), 1.97 g of benzene and 89.45 g of acetone were put into a 500-ml brown glass flask equipped with a three-way cock, and dissolved, and then 120.86 g of chloroprene was added thereto, and this was fully pumped in two freeze-pump-thaw cycles, and then heated in an oil bath at 50° C. with stirring with a magnetic stirrer in a nitrogen atmosphere, thereby giving an acetone solution of an acid group-terminated CR (CR-base polymer/thiomalic acid). After 65 hours, the polymerization conversion of chloroprene was 74.1%.

As determined through GPC, the number-average molecular weight Mn of the formed polymer was 2,700, and the weight-average molecular weight Mw thereof was 5,500.

Next, 19.32 g of the acetone solution of the acid group-terminated CR (CR-base polymer/thiomalic acid) produced in the above, 0.14 g of n-dodecylmercaptan, 0.31 g of benzene, 1.63 g (1.2 equivalents relative to the carboxyl group contained in the above solution) of triethylamine, and 40.18 g of pure water were put into a 200-ml glass flask equipped with a three-way cock, and mixed, and then 39.29 g of chloroprene and 0.2 ml of aqueous 3.40% by weight potassium persulfate solution were added thereto (the amount of the acid group-terminated CR added relative to the monomer was about 16.4% by weight). A nitrogen flow was applied to it for 30 minutes at a flow rate of 1 L/min for well pumping it, and heating it was started in an oil bath at 40° C. with stirring with a magnetic stirrer. This was polymerized for 9 hours with adding 0.2 ml of the above aqueous potassium persulfate solution thereto at intervals of 2 hours, and then 50 mg of phenothiazine was added to stop the polymerization. The chloroprene polymerization conversion was 90.20%, and no scale formed. The unreacted monomer, acetone and water were evaporated away with a rotary evaporator to obtain a CR-base latex-D (solid content, 48% by weight).

The Maron test deposition percentage of the CR-base latex-D was 0.0052% by weight; and the mean particle size thereof was 97 nm; and the latex had extremely high stability. (The carboxyl group content relative to the polymer in the latex was about 1.38% by weight.)

The adhesiveness potency of the obtained CR-base latex-D was evaluated, and the result is shown in Table 1. As compared with the comparative CR-base latex, the peeling strength reduction after the open time and the peeling strength reduction after dipping in water of the latex-D were small, and it is obvious that, as compared with the conventional latex, the adhesiveness and the water resistance of the latex-D are extremely improved.

### Example 5

10.34 g of thiomalic acid, 2.65 g of 4,4′-azobis(4-cyanopentanoic acid), 1.97 g of benzene and 89.45 g of acetone were put into a 500-ml brown glass flask equipped with a three-way cock, and dissolved, and then 120.86 g of chloroprene was added thereto, and this was fully pumped in two freeze-pump-thaw cycles, and then heated in an oil bath at 50° C. with stirring with a magnetic stirrer in a nitrogen atmosphere, thereby giving an acetone solution of an acid group-terminated CR (CR-base polymer/thiomalic acid). After 65 hours, the polymerization conversion of chloroprene was 74.1%.

As determined through GPC, the number-average molecular weight Mn of the formed polymer was 2,700, and the weight-average molecular weight Mw thereof was 5,500.

Next, 19.48 g of the acetone solution of the acid group-terminated CR (CR-base polymer/thiomalic acid) produced in the above, 0.14 g of n-dodecylmercaptan, 0.31 g of benzene, 4.56 g (1.2 equivalents relative to the carboxyl group contained in the above solution) of aqueous 20.42% by weight KOH solution, and 35.32 g of pure water were put into a 200-ml glass flask equipped with a three-way cock, and mixed, and then 42.16 g of chloroprene and 0.2 ml of aqueous 3.40% by weight potassium persulfate solution were added thereto (the amount of the acid group-terminated CR added relative to the monomer was about 15.5% by weight). A nitrogen flow was applied to it for 30 minutes at a flow rate of 1 L/min for well pumping it, and heating it was started in an oil bath at 40° C. with stirring with a magnetic stirrer. This was polymerized for 9 hours with adding 0.2 ml of the above aqueous potassium persulfate solution thereto at intervals of 2 hours, and then 50 mg of phenothiazine was added to stop the polymerization. The chloroprene polymerization conversion was 89.60%, and no scale formed. The unreacted monomer, acetone and water were evaporated away with a rotary evaporator to obtain a CR-base latex-E (solid content, 47% by weight).

The Maron test deposition percentage of the CR-base latex-E was 0.0084% by weight; and the mean particle size thereof was 112 nm; and the latex had extremely high stability. (The carboxyl group content relative to the polymer in the latex was about 1.32% by weight.)

The adhesiveness potency of the obtained CR-base latex-E was evaluated, and the result is shown in Table 1. As compared with the comparative CR-base latex, the peeling strength reduction after the open time and the peeling strength reduction after dipping in water of the latex-E were small, and it is obvious that, as compared with the conventional latex, the adhesiveness and the water resistance of the latex-E are extremely improved.

### Example 6

10.34 g of thiomalic acid, 2.65 g of 4,4′-azobis(4-cyanopentanoic acid), 1.97 g of benzene and 89.45 g of acetone were put into a 500-ml brown glass flask equipped with a three-way cock, and dissolved, and then 120.86 g of chloroprene was added thereto, and this was fully pumped in two freeze-pump-thaw cycles, and then heated in an oil bath at 50° C. with stirring with a magnetic stirrer in a nitrogen atmosphere, thereby giving an acetone solution of an acid group-terminated CR (CR-base polymer/thiomalic acid). After 65 hours, the polymerization conversion of chloroprene was 74.1%.

As determined through GPC, the number-average molecular weight Mn of the formed polymer was-2,700, and the weight-average molecular weight Mw thereof was 5,500.

Next, 14.00 g of the acetone solution of the acid group-terminated CR (CR-base polymer/thiomalic acid) produced in the above, 0.14 g of n-dodecylmercaptan, 0.31 g of benzene, 1.18 g (1.2 equivalents relative to the carboxyl group contained in the above solution) of triethylamine, 1.00 g of aqueous 25% by weight potassium rosinate solution, and 39.80 g of pure water were put into a 200-ml glass flask equipped with a three-way cock, and mixed, and then 39.29 g of chloroprene and 0.2 ml of aqueous 3.40% by weight potassium persulfate solution were added thereto (the amount of the acid group-terminated CR added relative to the monomer was about 12.41% by weight). A nitrogen flow was applied to it for 30 minutes at a flow rate of 1 L/min for well pumping it, and heating it was started in an oil bath at 40° C. with stirring with a magnetic stirrer. This was polymerized for 9 hours with adding 0.2 ml of the above aqueous potassium persulfate solution thereto at intervals of 2 hours, and then 50 mg of phenothiazine was added to stop the polymerization. The chloroprene polymerization conversion was 80.80%, and no scale formed. The unreacted monomer, acetone and water were evaporated away with a rotary evaporator to obtain a CR-base latex-F (solid content, 47% by weight).

The Maron test deposition percentage of the CR-base latex-F was 0.0052% by weight; and the mean particle size thereof was 105 nm; and the latex had extremely high stability. (The carboxyl group content relative to the polymer in the latex was about 1.05% by weight, and the amount of the conventional emulsifier therein was about 0.6% by weight.)

The adhesiveness potency of the obtained CR-base latex-F was evaluated, and the result is shown in Table 1. As compared with the comparative CR-base latex, the peeling strength reduction after the open time and the peeling strength reduction after dipping in water of the latex-F were small, and it is obvious that, as compared with the conventional latex, the adhesiveness and the water resistance of the latex-F are extremely improved.

### Example 7

10.34 g of thiomalic acid, 2.61 g of 4,4′-azobis(4-cyanopentanoic acid), 1.97 g of benzene and 89.02 g of acetone were put into a 500-ml brown glass flask equipped with a three-way cock, and dissolved, and then 100.03 g of chloroprene and 20.21 g of 2,3-dichloro-1,3-butadiene were added thereto, and this was fully pumped in two freeze-pump-thaw cycles, and then heated in an oil bath at 50° C. with stirring with a magnetic stirrer in a nitrogen atmosphere, thereby giving an acetone solution of an acid group-terminated CR (CR-base polymer/thiomalic acid). After 65 hours, the polymerization conversion of chloroprene and 2,3-dichloro-1,3-butadiene was 78.5% and 87.9%, respectively.

As determined through GPC, the number-average molecular weight Mn of the formed polymer was 3,100, and the weight-average molecular weight Mw thereof was 6,200.

Next, 18.80 g of the acetone solution of the acid group-terminated CR (CR-base polymer/thiomalic acid) produced in the above, 0.14 g of n-dodecylmercaptan, 0.31 g of benzene, 2.29 g (1.5 equivalents relative to the carboxyl group contained in the above solution) of N,N-diethylethanolamine, and 40.20 g of pure water were put into a 200-ml glass flask equipped with a three-way cock, and mixed, and then 30.02 g of chloroprene and 9.06 g of 2,3-dichloro-1,3-butadiene and 0.2 ml of aqueous 3.40% by weight potassium persulfate solution were added thereto (the amount of the acid group-terminated CR added relative to the monomer was about 17.1% by weight). A nitrogen flow was applied to it for 30 minutes at a flow rate of 1 L/min for well pumping it, and heating it was started in an oil bath at 40° C. with stirring with a magnetic stirrer. This was polymerized for 9 hours with adding 0.2 ml of the above aqueous potassium persulfate solution thereto at intervals of 2 hours, and then 50 mg of phenothiazine was added to stop the polymerization. The chloroprene and 2,3-dichloro-1,3-butadiene polymerization conversion was 88.1% and 94.0%, respectively; and no scale formed. The unreacted monomer, acetone and water were evaporated away with a rotary evaporator to obtain a CR-base latex-G (solid content, 48% by weight).

The Maron test deposition percentage of the CR-base latex-G was 0.0062% by weight; and the mean particle size thereof was 97 nm; and the latex had extremely high stability. (The carboxyl group content relative to the polymer in the latex was about 1.35% by weight.)

The adhesiveness potency of the obtained CR-base latex-G was evaluated, and the result is shown in Table 1. As compared with the comparative CR-base latex, the peeling strength reduction after the open time and the peeling strength reduction after dipping in water of the latex-G were small, and it is obvious that, as compared with the conventional latex, the adhesiveness and the water resistance of the latex-G are extremely improved.

### Example 8

10.34 g of thiomalic acid, 2.65 g of 4,4′-azobis(4-cyanopentanoic acid), 1.97 g of benzene and 89.45 g of methyl ethyl ketone were put into a 500-ml brown glass flask equipped with a three-way cock, and dissolved, and then 120.86 g of chloroprene was added thereto, and this was fully pumped in two freeze-pump-thaw cycles, and then heated in an oil bath at 50° C. with stirring with a magnetic stirrer in a nitrogen atmosphere, thereby giving a methyl ethyl ketone solution of an acid group-terminated CR (CR-base polymer/thiomalic acid). After 65 hours, the polymerization conversion of chloroprene was 76.2%.

As determined through GPC, the number-average molecular weight Mn of the formed polymer was 2,700, and the weight-average molecular weight Mw thereof was 5,600.

Next, 19.51 g of the methyl ethyl ketone solution of the acid group-terminated CR (CR-base polymer/thiomalic acid) produced in the above, 0.14 g of n-dodecylmercaptan, 0.31 g of benzene, 1.58 g (1.2 equivalents relative to the carboxyl group contained in the above solution) of triethylamine, and 40.32 g of pure water were put into a 200-ml glass flask equipped with a three-way cock, and mixed, and then 39.63 g of chloroprene and 0.2 ml of aqueous 3.40% by weight potassium persulfate solution were added thereto (the amount of the acid group-terminated CR added relative to the monomer was about 16.8% by weight). A nitrogen flow was applied to it for 30 minutes at a flow rate of 1 L/min for well pumping it, and heating it was started in an oil bath at 40° C. with stirring with a magnetic stirrer. This was polymerized for 9 hours with adding 0.2 ml of the above aqueous potassium persulfate solution thereto at intervals of 2 hours, and then 50 mg of phenothiazine was added to stop the polymerization. The chloroprene polymerization conversion was 92.2%, and no scale formed. The unreacted monomer, acetone and water were evaporated away with a rotary evaporator to obtain a CR-base latex-H (solid content, 48% by weight).

The Maron test deposition percentage of the CR-base latex-H was 0.0110% by weight; and the mean particle size thereof was 112 nm; and the latex had extremely high stability. (The carboxyl group content relative to the polymer in the latex was about 1.35% by weight.)

The adhesiveness potency of the obtained CR-base latex-H was evaluated, and the result is shown in Table 1. As compared with the comparative CR-base latex, the peeling strength reduction after the open time and the peeling strength reduction after dipping in water of the latex-H were small, and it is obvious that, as compared with the conventional latex, the adhesiveness and the water resistance of the latex-H are extremely improved.

### Example 9

6.00 g of 3,3′-dithiodipropionic acid, 0.70 g of 4,4′-azobis(4-cyanopentanoic acid), 0.54 g of benzene and 36.0 g of acetone were put into a 200-ml brown glass flask equipped with a three-way cock, and dissolved, and then 31.04 g of chloroprene was added thereto, and this was fully pumped in two freeze-pump-thaw cycles, and then heated in an oil bath at 50° C. with stirring with a magnetic stirrer in a nitrogen atmosphere, thereby giving an acetone solution of an acid group-terminated CR (CR-base polymer/3,3′-dithiodipropionic acid). After 65 hours, the polymerization conversion of chloroprene was 77.3%.

As determined through GPC, the number-average molecular weight Mn of the formed polymer was 4,200, and the weight-average molecular weight Mw thereof was 7,900.

Next, 10.01 g of the acetone solution of the acid group-terminated CR (CR-base polymer/3,31-dithiodipropionic acid) produced in the above, 0.14 g of n-dodecylmercaptan, 0.31 g of benzene, 1.96 g (2.0 equivalents relative to the carboxyl group contained in the above solution) of N,N-diethylethanolamine, and 40.00 g of pure water were put into a 200-ml glass flask equipped with a three-way cock, and mixed, and then 38.00 g of chloroprene and 0.2 ml of aqueous 3.40% by weight potassium persulfate solution were added thereto (the amount of the acid group-terminated CR added relative to the monomer was about 10% by weight). A nitrogen flow was applied to it for 30 minutes at a flow rate of 1 L/min for well pumping it, and heating it was started in an oil bath at 40° C. with stirring with a magnetic stirrer. This was polymerized for 9 hours with adding 0.2 ml of the above aqueous potassium persulfate solution thereto at intervals of 2 hours, and then 50 mg of phenothiazine was added to stop the polymerization. The chloroprene polymerization conversion was 86.3%, and no scale formed. The unreacted monomer, acetone and water were evaporated away with a rotary evaporator to obtain a CR-base latex-I (solid content, 48% by weight).

The Maron test deposition percentage of the CR-base latex-I was 0.0102% by weight; and the mean particle size thereof was 120 nm; and the latex had extremely high stability. (The carboxyl group content relative to the polymer in the latex was about 1.0% by weight.)

The adhesiveness potency of the obtained CR-base latex-I was evaluated, and the result is shown in Table 2. As compared with the comparative CR-base latex, the peeling strength reduction after the open time and the peeling strength reduction after dipping in water of the latex-I were small, and it is obvious that, as compared with the conventional latex, the adhesiveness and the water resistance of the latex-I are extremely improved.

TABLE 2

| | | | | | | Comparative | Comparative |
|---|---|---|---|---|---|---|---|
| | | Example 9 | Example 10 | Example 11 | Example 12 | Example 1 | Example 3 |
| Formulation (wt. pt.) | | | | | | | |
| CR-base latex-I | | 100 | — | — | — | — | — |
| CR-base latex-J | | — | 100 | — | — | — | — |
| CR-base latex-K | | — | — | 100 | — | — | — |
| CR-base latex-L | | — | — | — | 100 | — | — |
| CR-base latex-M | | — | — | — | — | 100 | — |
| CR-base latex-O | | — | — | — | — | — | 100 |
| Ordinary Peeling | | | | | | | |
| Strength (N/25 mm)¹⁾ | | | | | | | |
| open time | 0.5 hrs | 66C | 60C | 65C | 65C | 10S | 7S |
| | 1 hr | 65C | 60C | 60C | 60C | 9S | 5S |
| | 2 hrs | 60C/S | 56C/S | 55C/S | 55C/S | 5S | 5S |

| | | | | | | |
|---|---|---|---|---|---|---|
| Water-Resistant Peeling | 59C | 59C | 55C | 55C | 5S | 5S |
| Strength (N/25 mm)¹⁾ | | | | | | |

¹⁾Peeling State: C = cohesive failure in the adhesive layer. S = peeling at the adhesive interface.

### Example 10

6.5 g of 2,2′-dithiobisbenzoic acid, 0.70 g of 4,4′-azobis(4-cyanopentanoic acid), 0.55 g of benzene and 36.0 g of tetrahydrofuran were put into a 200-ml brown glass flask equipped with a three-way cock, and dissolved, and then 31.10 g of chloroprene was added thereto, and this was fully pumped in two freeze-pump-thaw cycles, and then heated in an oil bath at 50° C. with stirring with a magnetic stirrer in a nitrogen atmosphere, thereby giving a tetrahydrofuran solution of an acid group-terminated CR (CR-base polymer/2,2′-dithiobisbenzoic acid). After 65 hours, the polymerization conversion of chloroprene was 79.0%.

As determined through GPC, the number-average molecular weight Mn of the formed polymer was 4,100, and the weight-average molecular weight Mw thereof was 7,900.

Next, 10.00 g of the tetrahydrofuran solution of the acid group-terminated CR (CR-base polymer/2,2′-dithiobisbenzoic acid) produced in the above, 0.14 g of n-dodecylmercaptan, 0.30 g of benzene, 1.48 g (2.0 equivalents relative to the carboxyl group contained in the above solution) of N,N-diethylethanolamine, and 40.00 g of pure water were put into a 200-ml glass flask equipped with a three-way cock, and mixed, and then 38.00 g of chloroprene and 0.2 ml of aqueous 3.40% by weight potassium persulfate solution were added thereto (the amount of the acid group-terminated CR added relative to the monomer was about 11% by weight). A nitrogen flow was applied to it for 30 minutes at a flow rate of 1 L/min for well pumping it, and heating it was started in an oil bath at 40° C. with stirring with a magnetic stirrer. This was polymerized for 9 hours with adding 0.2 ml of the above aqueous potassium persulfate solution thereto at intervals of 2 hours, and then 50 mg of phenothiazine was added to stop the polymerization. The chloroprene polymerization conversion was 84.0%, and no scale formed. The unreacted monomer, tetrahydrofuran and water were evaporated away with a rotary evaporator to obtain a CR-base latex-J (solid content, 48% by weight).

The Maron test deposition percentage of the CR-base latex-J was 0.0110% by weight; and the mean particle size thereof was 120 nm; and the latex had extremely high stability. (The carboxyl group content relative to the polymer in the latex was about 0.8% by weight.)

The adhesiveness potency of the obtained CR-base latex-J was evaluated, and the result is shown in Table 2. As compared with the comparative CR-base latex, the peeling strength reduction after the open time and the peeling strength reduction after dipping in water of the latex-J were small, and it is obvious that, as compared with the conventional latex, the adhesiveness and the water resistance of the latex-J are extremely improved.

### Example 11

4.00 g of thiomalic acid, 0.20 g of 3,3′-dithiodipropionic acid, 1.05 g of 4,4′-azobis(4-cyanopentanoic acid), 0.80 g of benzene and 35.60 g of acetone were put into a 200-ml glass flask equipped with a three-way cock, and dissolved, and then 48.80 g of chloroprene was added thereto, and this was fully pumped in two freeze-pump-thaw cycles, and then heated in an oil bath at 50° C. with stirring with a magnetic stirrer in a nitrogen atmosphere, thereby giving an acetone solution of an acid group-terminated CR (CR-base polymer/thiomalic acid/3,3′-dithiodipropionic acid). After 77 hours, the polymerization conversion of chloroprene was 76.0%.

As determined through GPC, the number-average molecular weight Mn of the formed polymer was 2,800, and the weight-average molecular weight Mw thereof was 5,300.

Next, 9.51 g of the acetone solution of the acid group-terminated CR (CR-base polymer/thiomalic acid/3,3′-dithiodipropionic acid) produced in the above, 0.13 g of n-dodecylmercaptan, 0.15 g of benzene, 1.54 g (2.0 equivalents relative to the carboxyl group contained in the above solution) of N,N-diethylethanolamine, and 34.20 g of pure water were put into a 200-ml glass flask equipped with a three-way cock, and mixed, and then 35.22 g of chloroprene and 0.2 ml of aqueous 3.40% by weight potassium persulfate solution were added thereto (the amount of the acid group-terminated CR added relative to the monomer was about 8% by weight). A nitrogen flow was applied to it for 30 minutes at a flow rate of 1 L/min for well pumping it, and heating it was started in an oil bath at 40° C. with stirring with a magnetic stirrer. This was polymerized for 9 hours with adding 0.2 ml of the above aqueous potassium persulfate solution thereto at intervals of 2 hours, and then 50 mg of phenothiazine was added to stop the polymerization. The chloroprene polymerization conversion was 86.0%, and no scale formed. The unreacted monomer, acetone and water were evaporated away with a rotary evaporator to obtain a CR-base latex-K (solid content, 48% by weight).

The Maron test deposition percentage of the CR-base latex-K was 0.0065% by weight; and the mean particle size thereof was 97 nm; and the latex had extremely high stability. (The carboxyl group content relative to the polymer in the latex was about 0.87% by weight.)

The adhesiveness potency of the obtained CR-base latex-K was evaluated, and the result is shown in Table 2. As compared with the comparative CR-base latex, the peeling strength reduction after the open time and the peeling strength reduction after dipping in water of the latex-K were small, and it is obvious that, as compared with the conventional latex, the adhesiveness and the water resistance of the latex-K are extremely improved.

### Example 12

4.00 g of thiomalic acid, 0.20 g of-2,2′-dithiobisbenzoic acid, 1.06 g of 4,4′-azobis(4-cyanopentanoic acid), 0.78 g of benzene and 35.57 g of acetone were put into a 200-ml glass flask equipped with a three-way cock, and dissolved, and then 48.67 g of chloroprene was added thereto, and this was fully pumped in two freeze-pump-thaw cycles, and then heated in an oil bath at 50° C. with stirring with a magnetic stirrer in a nitrogen atmosphere, thereby giving an acetone solution of an acid group-terminated CR (CR-base polymer/thiomalic acid/2,2′-dithiobisbenzoic acid). After 77 hours, the polymerization conversion of chloroprene was 79.0%.

As determined through GPC, the number-average molecular weight Mn of the formed polymer was 3,000, and the weight-average molecular weight Mw thereof was 5,500.

Next, 9.51 g of the acetone solution of the acid group-terminated CR (CR-base polymer/thiomalic acid/3,3′-dithiobisbenzoic acid) produced in the above, 0.13 g of n-dodecylmercaptan, 0.15 g of benzene, 1.53 g (2.0 equivalents relative to the carboxyl group contained in the above solution) of N,N-diethylethanolamine, and 34.50 g of pure water were put into a 200-ml glass flask equipped with a three-way cock, and mixed, and then 35.50 g of chloroprene and 0.2 ml of aqueous 3.40% by weight potassium persulfate solution were added thereto (the amount of the acid group-terminated CR added relative to the monomer was about 8% by weight). A nitrogen flow was applied to it for 30 minutes at a flow rate of 1 L/min for well pumping it, and heating it was started in an oil bath at 40° C. with stirring with a magnetic stirrer. This was polymerized for 9 hours with adding 0.2 ml of the above aqueous potassium persulfate solution thereto at intervals of 2 hours, and then 50 mg of phenothiazine was added to stop the polymerization. The chloroprene polymerization conversion was 86.0%, and no scale formed. The unreacted monomer, acetone and water were evaporated away with a rotary evaporator to obtain a CR-base latex-L (solid content, 48% by weight).

The Maron test deposition percentage of the CR-base latex-L was 0.0066% by weight; and the mean particle size thereof was 97 nm; and the latex had extremely high stability. (The carboxyl group content relative to the polymer in the latex was about 0.85% by weight.)

The adhesiveness potency of the obtained CR-base latex-L was evaluated, and the result is shown in Table 2. As compared with the comparative CR-base latex, the peeling strength reduction after the open time and the peeling strength reduction after dipping in water of the latex-L were small, and it is obvious that, as compared with the conventional latex, the adhesiveness and the water resistance of the latex-L are extremely improved.

### Comparative Example 1

2.00 g of sodium dodecylbenzenesulfonate, and 40.18 g of pure water were put into a 200-ml glass flask equipped with a three-way cock, and dissolved, and then 0.14 g of n-dodecylmercaptan, 0.31 g of benzene, 46.97 g of chloroprene and 0.2 ml of aqueous 3.40% by weight potassium persulfate solution were added thereto. A nitrogen flow was applied to it for 30 minutes at a flow rate of 1 L/min for well pumping it, and heating it was started in an oil bath at 40° C. with stirring with a magnetic stirrer. This was polymerized for 6 hours with adding 0.2 ml of the above aqueous potassium persulfate solution thereto at intervals of 2 hours, and then 50 mg of phenothiazine was added to stop the polymerization. The chloroprene polymerization conversion was 92.6%, and no scale formed. The unreacted monomer was evaporated away with a rotary evaporator to obtain a CR-base latex-M (solid content, 47% by weight).

The Maron test deposition percentage of the CR-base latex-M was 0.0120% by weight; and the mean particle size thereof was 105 nm; and the latex had extremely high stability. (The conventional emulsifier content relative to the polymer in the latex was 4.4% by weight.)

The adhesiveness potency of the obtained CR-base latex M was evaluated, and the result is shown in Table 2. It is obvious that, as compared with the CR-base latex of Examples, the peeling strength reduction after the open time and the peeling strength reduction after dipping in water of the latex-M are great.

### Comparative Example 2

10.3 g of thiomalic acid, 2.65 g of 4,4′-azobis(4-cyanopentanoic acid), 1.97 g of benzene and 89.45 g of acetone were put into a 500-ml brown glass flask equipped with a three-way cock, and dissolved, and then 120.86 g of chloroprene was added thereto, and this was fully pumped in two freeze-pump-thaw cycles, and then heated in an oil bath at 50° C. with stirring with a magnetic stirrer in a nitrogen atmosphere, thereby giving an acetone solution of an acid group-terminated CR (CR-base polymer/thiomalic acid). After 65 hours, the polymerization conversion of chloroprene was 74.1%.

As determined through GPC, the number-average molecular weight Mn of the formed polymer was 2,700, and the weight-average molecular weight Mw thereof was 5,500.

Next, 19.32 g of the acetone solution of the acid group-terminated CR (CR-base polymer/thiomalic acid) produced in the above, 1.63 g (1.2 equivalents relative to the carboxyl group contained in the above polymerization solution) of triethylamine, and 40.18 g of pure water were weighed and put into a 200-ml egg-plant flask, and mixed, and then acetone was evaporated away with a rotary evaporator. The contents were transferred into a 200-ml glass flask equipped with a three-way cock, and 0.14 g of n-dodecylmercaptan and 0.31 g of benzene were added thereto, and with stirring, 46.97 g of chloroprene was added to it, and then 0.2 ml of aqueous 3.40% by weight potassium persulfate solution was added thereto (the amount of the acid group-terminated CR added relative to the monomer was about 16.35% by weight). A nitrogen flow was applied to it for 30 minutes at a flow rate of 1 L/min for well pumping it, and heating it was started in an oil bath at 40° C. with stirring with a magnetic stirrer. This was polymerized for 9 hours with adding 0.2 ml of the above aqueous potassium persulfate solution thereto at intervals of 2 hours, and then 50 mg of phenothiazine was added to stop the polymerization. The chloroprene polymerization conversion was 82.6% and was somewhat low, and massive scale formed. The unreacted monomer was evaporated away with a rotary evaporator to obtain a CR-base latex-N (solid content, 39% by weight).

The mean particle size of the CR-base latex N was 135 nm, and the latex contained large particles having a particle size of thousands nm. The latex stability was significantly inferior to that in Examples. Since the latex stability was poor, the latex was not worthy of being tested for the adhesiveness thereof.

### Comparative Example 3

5.00 g of Pelex SSH (manufactured by KAO CORPORATION, sodium dodecyldiphenylether-disulfonate), 46.00 g of pure water, 0.15 g of n-dodecylmercaptan, 0.30 g of benzene and 55.23 g of chloroprene were put into a 200-ml glass flask equipped with a three-way cock, thereby preparing a monomer emulsion. To it was added 0.2 ml of an aqueous initiator solution (containing 3.40% by weight of potassium persulfate and 0.10% by weight of sodium anthraquinonesulfonate). A nitrogen flow was applied to it for 30 minutes at a flow rate of 1 L/min for well pumping it, and heating it was started in an oil bath at 40° C. with stirring with a magnetic stirrer. This was polymerized for 8 hours with adding 0.2 ml of the above aqueous initiator solution thereto at intervals of 2 hours, and then 50 mg of phenothiazine was added to stop the polymerization. The chloroprene polymerization conversion was 95%, and no scale formed. The unreacted monomer and water were evaporated away with a rotary evaporator to obtain a CR-base latex-O (solid content, 47% by weight).

The adhesiveness potency of the obtained CR-base latex O was evaluated, and the result is shown in Table 2. It is obvious that, as compared with the CR-base latex of Examples, the peeling strength reduction after the open time and the peeling strength reduction after dipping in water of the latex-O are great.

### Synthetic Example 1

91.2 g of tetrahydrofuran, 3.00 g of O,O-diisopropyl dithiobis(thioformate), 0.80 g of 4,4,-azobis(4-cyanopentanoic acid) and 22.08 g of maleic acid were put into a 500-ml Pyrex™ glass flask equipped with a nitrogen gas take-in duct and a reflux condenser, and dissolved, and then 33.55 g of chloroprene and 1.32 g of benzene were added thereto, and this was fully pumped in two freeze-pump-thaw cycles, and then heated in an oil bath at 50° C. with stirring with a magnetic stirrer in a nitrogen atmosphere. After heated for 88 hours, this was cooled to room temperature, and a stabilizer phenothiazine was added thereto. At this point, the polymerization conversion of chloroprene was 74.3%. The contents were poured into a large amount of pure water to give a polymer deposit, and dried under reduced pressure. The weight of the dry polymer was 25.12 g; and, as determined through GPC, the number-average molecular weight Mn of the formed polymer was 7,900, and the weight-average molecular weight Mw thereof was 13,500. As determined through neutralization titration, the carboxyl group content in the formed polymer was 7% by weight.

The dry polymer was dissolved in 50.00 g of acetone, and 4.74 g (1.2 equivalents relative to the carboxyl group contained in the formed polymer) of triethylamine was added to it, and 110.0 g of pure water was added to obtain an aqueous solution-A of CR random copolymer (chloroprene/maleic acid random copolymer).

### Synthetic Example 2

122.2 g of tetrahydrofuran, 2.00 g of thiomalic acid, 0.76 g of-4,4′-azobis(4-cyanopentanoic acid) and 7.66 g of maleic anhydride were put into a 500-ml Pyrex™ glass flask equipped with a nitrogen gas take-in duct and a reflux condenser, and dissolved, and then 37.05 g of chloroprene and 2.27 g of benzene were added thereto, and this was fully pumped in two freeze-pump-thaw cycles, and then heated in an oil bath at 50° C. with stirring with a magnetic stirrer in a nitrogen atmosphere. After heated for 64 hours, this was cooled to room temperature, and a stabilizer phenothiazine was added thereto. At this point, the polymerization conversion of chloroprene and maleic anhydride was 75.2% and 98.5%. The contents were poured into a large amount of pure water to give a polymer deposit, and dried under reduced pressure. The weight of the dry polymer was 32.10 g; and, as determined through GPC, the number-average molecular weight Mn of the formed polymer was 7,600, and the weight-average molecular weight Mw thereof was 13,900. As determined through neutralization titration, the carboxyl group content in the formed polymer was 10% by weight.

The dry polymer was dissolved in 100.0 g of tetrahydrofuran, and 8.65 g (1.2 equivalents relative to the carboxyl group contained in the formed polymer) of triethylamine was added to it, and 130.0 g of pure water was added thereto. Tetrahydrofuran was evaporated away under reduced pressure to obtain an aqueous solution-B of CR random copolymer (chloroprene/maleic anhydride random copolymer).

### Synthetic Example 3

51.01 g of tetrahydrofuran, 1.56 g of O,O-diethyl dithiobis(thioformate), 0.30 g of 4,4′-azobis(4-cyanopentanoic acid) and 3.01 g of maleic anhydride were put into a 500-ml Pyrex™ glass flask equipped with a nitrogen gas take-in duct and a reflux condenser, and dissolved, and then 15.40 g of chloroprene and 1.52 g of benzene were added thereto, and this was fully pumped in two freeze-pump-thaw cycles, and then heated in an oil bath at 50° C. with stirring with a magnetic stirrer in a nitrogen atmosphere. After heated for 64 hours, this was cooled to room temperature, and a stabilizer phenothiazine was added thereto. At this point, the polymerization conversion of chloroprene and maleic anhydride was 70.8% and 99.2%. The contents were poured into a large amount of pure water to give a polymer deposit, and dried under reduced pressure. The weight of the dry polymer was 12.36 g; and, as determined through GPC, the number-average molecular weight Mn of the formed polymer was 6,500, and the weight-average molecular weight Mw thereof was 13,300. As determined through neutralization titration, the carboxyl group content in the formed polymer was 10% by weight.

The dry polymer was dissolved in 41.0 g of tetrahydrofuran, and 3.33 g (1.2 equivalents relative to the carboxyl group contained in the formed polymer) of triethylamine was added to it, and 50.0 g of pure water was added thereto. Tetrahydrofuran was evaporated away under reduced pressure to obtain an aqueous solution-C of CR random copolymer (chloroprene/maleic anhydride random copolymer).

### Synthetic Example 4

90.0 g of acetone, 5.00 g of β-mercaptopropionic acid, 0.80 g of 4,4′-azobis(4-cyanopentanoic acid) and 20.00 g of methacrylic acid were put into a 500-ml Pyrex™ glass flask equipped with a nitrogen gas take-induct and a reflux condenser, and dissolved, and then 40.00 g of chloroprene and 1.32 g of benzene were added thereto, and this was fully pumped in two freeze-pump-thaw cycles, and then heated in an oil bath at 50° C. with stirring with a magnetic stirrer in a nitrogen atmosphere. After heated for 88 hours, this was cooled to room temperature, and a minor amount of a stabilizer phenothiazine was added thereto. At this point, the polymerization conversion of chloroprene was 76.7%. The contents were poured into a large amount of pure water to give a polymer deposit, and dried under reduced pressure. The weight of the dry polymer was 25.12 g; and, as determined through GPC, the number-average molecular weight Mn of the formed polymer was 5,900, and the weight-average molecular weight Mw thereof was 12,300. As determined through neutralization titration, the carboxyl group content in the formed polymer was 6% by weight.

The dry polymer was dissolved in 45.00 g of acetone, and 4.06 g (1.2 equivalents relative to the carboxyl group contained in the formed polymer) of triethylamine was added to it, and 110.0 g of pure water was added to obtain an aqueous solution-D of CR random copolymer (chloroprene/methacrylic acid random copolymer).

### Synthetic Example 5

90.0 g of acetone, 6.00 g of β-mercaptopropionic acid, 0.80 g of 4,4′-azobis(4-cyanopentanoic acid) and 25.00 g of vinylacetic acid were put into a 500-ml Pyrex™ glass flask equipped with a nitrogen gas take-in duct and a reflux condenser, and dissolved, and then 40.00 g of chloroprene and 1.32 g of benzene were added thereto, and this was fully pumped in two freeze-pump-thaw cycles, and then heated in an oil bath at 50° C. with stirring with a magnetic stirrer in a nitrogen atmosphere. After heated for 88 hours, this was cooled to room temperature, and a minor amount of a stabilizer phenothiazine was added thereto. At this point, the polymerization conversion of chloroprene was 69.8%. The contents were poured into a large amount of pure water to give a polymer deposit, and dried under reduced pressure. The weight of the dry polymer was 23.05 g; and, as determined through GPC, the number-average molecular weight Mn of the formed polymer was 3,900, and the weight-average molecular weight Mw thereof was 8,750. As determined through neutralization titration, the carboxyl group content in the formed polymer was 7% by weight.

The dry polymer was dissolved in 40.00 g of acetone, and 4.53 g (1.2 equivalents relative to the carboxyl group contained in the formed polymer) of diethanolamine was added to it, and 105.0 g of pure water was added to obtain an aqueous solution-E of CR random copolymer (chloroprene/vinylacetic acid random copolymer).

### Synthetic Example 6

122.2 g of tetrahydrofuran, 0.25 g of 4,4′-azobis(4-cyanopentanoic acid) and 5.55 g of maleic anhydride were put into a 500-ml Pyrex™ glass flask equipped with a nitrogen gas take-in duct and a reflux condenser, and dissolved, and then 12.35 g of chloroprene and 0.76 g of benzene were added thereto, and this was fully pumped in two freeze-pump-thaw cycles, and then heated in an oil bath at 50° C. with stirring with a magnetic stirrer in a nitrogen atmosphere. After heated for 64 hours, this was cooled to room temperature, and a stabilizer phenothiazine was added thereto. At this point, the polymerization conversion of chloroprene and maleic anhydride was 82.0% and 97.5%. The contents were poured into a large amount of pure water to give a polymer deposit, and dried under reduced pressure. The weight of the dry polymer was 11.96 g; and, as determined through GPC, the number-average molecular weight Mn of the formed polymer was 213,000, and the weight-average molecular weight Mw thereof was 392,000. As determined through neutralization titration, the carboxyl group content in the formed polymer was about 22% by weight.

The dry polymer was dissolved in 70.5 g of tetrahydrofuran, and 7.14 g (1.2 equivalents relative to the carboxyl group contained in the formed polymer) of triethylamine was added to it, and 70.0 g of pure water was added thereto. Tetrahydrofuran was evaporated away under reduced pressure to obtain an aqueous solution-F of CR random copolymer (chloroprene/maleic anhydride random copolymer).

### Synthetic Example 7

90.0 g of tetrahydrofuran, 3.00 g of O,O-diisopropyl dithiobis(thioformate), 0.35 g of 4,4′-azobisisobutyronitrile and 22.00 g of polyethylene glycol methacrylate (molecular weight, ˜360; number of ethyleneoxide molecules added, ˜5) were put into a 500-ml Pyrex™ glass flask equipped with a nitrogen gas take-in duct and a reflux condenser, and dissolved, and then 33.60 g of chloroprene and 1.30 g of benzene were added thereto, and this was fully pumped in two freeze-pump-thaw cycles, and then heated in an oil bath at 50° C. with stirring with a magnetic stirrer in a nitrogen atmosphere. After heated for 112 hours, this was cooled to room temperature, and a stabilizer phenothiazine was added thereto. At this point, the polymerization conversion of chloroprene was 87.0%; and, as determined through GPC, the number-average molecular weight Mn of the formed polymer was 4,600, and the weight-average molecular weight Mw thereof was 9,300.

110 g of pure water was added to the above polymerization solution. Tetrahydrofuran and the unreacted chloroprene were evaporated away under reduced pressure to obtain an aqueous solution-G of CR random copolymer (chloroprene/polyethylene glycol methacrylate random copolymer).

### Synthetic Example 8

90.0 g of tetrahydrofuran, 3.00 g of n-dodecylmercaptan, 0.35 g of 4,4′-azobisisobutyronitrile and 22.00 g of diethylaminoethyl methacrylate were put into a 500-ml Pyrex™ glass flask equipped with a nitrogen gas take-in duct and a reflux condenser, and dissolved, and then 33.70 g of chloroprene and 1.30 g of benzene were added thereto, and this was fully pumped in two freeze-pump-thaw cycles, and then heated in an oil bath at 50° C. with stirring with a magnetic stirrer in a nitrogen atmosphere. After heated for 112 hours, this was cooled to room temperature, and a stabilizer phenothiazine was added thereto. At this point, the polymerization conversion of chloroprene was 85.0%. The contents were poured into a large amount of pure water to give a polymer deposit, and dried under reduced pressure. The weight of the dry polymer was 26.40 g; and, as determined through GPC, the number-average molecular weight Mn of the formed polymer was 6,300, and the weight-average molecular weight Mw thereof was 10,200. The chlorine content in the formed polymer was 35.5% by weight. (The diethylaminoethyl methacrylate component in the dry polymer was about 2.97 g, ˜16.05 mmol.)

The dry polymer was dissolved in 90.00 g of tetrahydrofuran, and 1.67 g of 35% by weight hydrochloric acid and 110.0 g of pure water were added thereto. Tetrahydrofuran was evaporated away under reduced pressure to obtain an aqueous solution-H of CR random copolymer (chloroprene/diethylaminoethyl methacrylate random copolymer).

### Example 13

61.05 g of the aqueous solution-A of CR random copolymer obtained in Synthetic Example 1 (the amount of the hydrophilic group-having CR random copolymer used was 8.08 g, and 14% by weight of the monomer), 0.05 g of n-dodecylmercaptan, and 50.00 g of chloroprene were put into a 200-ml flask equipped with a nitrogen gas take-in duct and a stirrer, and with stirring, the system was fully pumped with a small amount of a nitrogen flow given thereinto, and then, in a nitrogen atmosphere, this was polymerized at 50° C. with successively adding an aqueous initiator solution (containing 3.00% by weight of potassium persulfate and 0.03% by weight of sodium anthraquinonesulfonate) thereto. After heated for 9 hours, 60 mg of phenothiazine was added to stop the polymerization. The polymerization conversion of chloroprene was 88%. The unreacted monomer and water were evaporated away using a rotary evaporator to obtain a CR-base latex-P (solid content, 45% by weight; the carboxyl group content relative to the overall polymer in the latex was about 1.1% by weight). The mean particle size of the latex was 97 μm, and the Maron test deposition percentage was 0.0060% by weight. The latex stability was extremely good.

The adhesiveness potency of the obtained CR-base latex-P was evaluated, and the result is shown in Table 3. As compared with the comparative CR-base latex, the peeling strength reduction after the open time and the peeling strength reduction after dipping in water of the latex-P were small, and it is obvious that, as compared with the conventional latex, the adhesiveness and the water resistance of the latex-P are extremely improved.

TABLE 3

| Ordinary Peeling | | Example | Example | Example | Example | Example | Example | Example | Example |
|---|---|---|---|---|---|---|---|---|---|
| Strength (N/25 mm)¹⁾ | | 13 | 14 | 15 | 16 | 17 | 18 | 19 | 20 |
| open time | 0 hr | 54C | 53C | 56C | 51C | 56C | 55C | 53C | 52C |
| | 1 hr | 55C | 50C | 54C/S | 52C | 55C | 55C | 51C/S | 49S/C |
| | 3 hrs | 47C/S | 48C/S | 50C/S | 49C/S | 46C/S | 45C/S | 41C/S | 40S/C |

| | | | | | | | | |
|---|---|---|---|---|---|---|---|---|
| Water-Resistant Peeling | 43C/S | 43C/S | 42C | 41C/S | 40C/S | 40C/S | 35S/C | 34S/C |
| Strength (N/25 mm)¹⁾ | | | | | | | | |

¹⁾Peeling State: C = cohesive failure in the adhesive layer. S = peeling at the adhesive interface.

### Example 14

61.05 g of the aqueous solution-A of CR random copolymer obtained in Synthetic Example 1 (the amount of the hydrophilic group-having CR random copolymer used was 8.08 g, and 14% by weight of the monomer), 0.05 g of n-dodecylmercaptan, 45.00 g of chloroprene and 5.00 g of 2,3-dichloro-1,3-butadiene were put into a 200-ml flask equipped with a nitrogen gas take-in duct and a stirrer, and with stirring, the system was fully pumped with a small amount of a nitrogen flow given thereinto, and then, in a nitrogen atmosphere, this was polymerized at 40° C. with successively adding an aqueous initiator solution (containing 3.00% by weight of potassium persulfate and 0.03% by weight of sodium anthraquinonesulfonate) thereto. After heated for 9 hours, 60 mg of phenothiazine was added to stop the polymerization. The polymerization conversion of chloroprene and 2,3-dichloro-1,3-butadiene was 84% and 95%. The unreacted monomer and water were evaporated away using a rotary evaporator to obtain a CR-base latex-Q (solid content, 45% by weight; the carboxyl group content relative to the overall polymer in the latex was about 1.1% by weight). The mean particle size of the latex was 115 μm, and the Maron test deposition percentage was 0.0100% by weight. The latex stability was extremely good.

The adhesiveness potency of the obtained CR-base latex-Q was evaluated, and the result is shown in Table 3. As compared with the comparative CR-base latex, the peeling strength reduction after the open time and the peeling strength reduction after dipping in water of the latex-Q were small, and it is obvious that, as compared with the conventional latex, the adhesiveness and the water resistance of the latex-Q are extremely improved.

### Example 15

Chloroprene and 2,3-dichloro-1,3-butadiene were emulsion-polymerized under the same condition as in Example 14 except that 59.00 g of the aqueous solution-B of CR random copolymer obtained in Synthetic Example 2 (the amount of the hydrophilic group-having CR random copolymer used was 8.21 g, and 14% by weight of the monomer) was used in place of the aqueous solution-A of CR random copolymer obtained in Synthetic Example 1 used in Example 14. After heated for 9 hours, 60 mg of phenothiazine was added to stop the polymerization. The polymerization conversion of chloroprene and 2,3-dichloro-1,3-butadiene was 87% and 96%. The unreacted monomer and water were evaporated away using a rotary evaporator to obtain a CR-base latex-R (solid content, 46% by weight; the carboxyl group content relative to the overall polymer in the latex was about 1.5% by weight). The mean particle size of the latex was 115 μm, and the Maron test deposition percentage was 0.0100% by weight. The latex stability was extremely good.

The adhesiveness potency of the obtained CR-base latex-R was evaluated, and the result is shown in Table 3. As compared with the comparative CR-base latex, the peeling strength reduction after the open time and the peeling strength reduction after dipping in water of the latex-R were small, and it is obvious that, as compared with the conventional latex, the adhesiveness and the water resistance of the latex-R are extremely improved.

### Example 16

61.10 g of the aqueous solution-C of CR random copolymer obtained in Synthetic Example 3 (the amount of the hydrophilic group-having CR random copolymer used was 7.89 g, and 14% by weight of the monomer), 0.05 g of n-dodecylmercaptan and 50.00 g of chloroprene were put into a 200-ml flask equipped with a nitrogen gas take-in duct and a stirrer, and with stirring, the system was fully pumped with a small amount of a nitrogen flow given thereinto, and then, in a nitrogen atmosphere, this was polymerized at 40° C. with successively adding an aqueous initiator solution (containing 3.00% by weight of potassium persulfate and 0.03% by weight of sodium anthraquinonesulfonate) thereto. After heated for 9 hours, 60 mg of phenothiazine was added to stop the polymerization. The polymerization conversion of chloroprene was 84%. The unreacted monomer and water were evaporated away using a rotary evaporator to obtain a CR-base latex-S (solid content, 46% by weight; the carboxyl group content relative to the overall polymer in the latex was about 1.6% by weight). The mean particle size of the latex was 115 μm, and the Maron test deposition percentage was 0.0101% by weight. The latex stability was extremely good.

The adhesiveness potency of the obtained CR-base latex-S was evaluated, and the result is shown in Table 3. As compared with the comparative CR-base latex, the peeling strength reduction after the open time and the peeling strength reduction after dipping in water of the latex-S were small, and it is obvious that, as compared with the conventional latex, the adhesiveness and the water resistance of the latex-S are extremely improved.

### Example 17

61.5 g of the aqueous solution-D of CR random copolymer obtained in Synthetic Example 4 (the amount of the hydrophilic group-having CR random copolymer used was 8.39 g, and 14% by weight of the monomer), 0.05 g of n-dodecylmercaptan and 50.00 g of chloroprene were put into a 200-ml flask equipped with a nitrogen gas take-in duct and a stirrer, and with stirring, the system was fully pumped with a small amount of a nitrogen flow given thereinto, and then, in a nitrogen atmosphere, this was polymerized at 40° C. with successively adding an aqueous initiator solution (containing 3.00% by weight of potassium persulfate and 0.03% by weight of sodium anthraquinonesulfonate) thereto. After heated for 9 hours, 60 mg of phenothiazine was added to stop the polymerization. The polymerization conversion of chloroprene was 82%. The unreacted monomer and water were evaporated away using a rotary evaporator to obtain a CR-base latex-T (solid content, 46% by weight; the carboxyl group content relative to the overall polymer in the latex was about 1.0% by weight). The mean particle size of the latex was 96 μm, and the Maron test deposition percentage was 0.0054% by weight. The latex stability was extremely good.

The adhesiveness potency of the obtained CR-base latex-T was evaluated, and the result is shown in Table 3. As compared with the comparative CR-base latex, the peeling strength reduction after the open time and the peeling strength reduction after dipping in water of the latex-T were small, and it is obvious that, as compared with the conventional latex, the adhesiveness and the water resistance of the latex-T are extremely improved.

### Example 18

56.00 g of the aqueous solution-E of CR random copolymer obtained in Synthetic Example 5 (the amount of the hydrophilic group-having CR random copolymer used was 7.68 g, and 13% by weight of the monomer), 0.05 g of n-dodecylmercaptan and 50.00 g of chloroprene were put into a 200-ml flask equipped with a nitrogen gas take-in duct and a stirrer, and with stirring, the system was fully pumped with a small amount of a nitrogen flow given thereinto, and then, in a nitrogen atmosphere, this was polymerized at 40° C. with successively adding an aqueous initiator solution (containing 3.00% by weight of potassium persulfate and 0.03% by weight of sodium anthraquinonesulfonate) thereto. After heated for 9 hours, 60 mg of phenothiazine was added to stop the polymerization. The polymerization conversion of chloroprene was 82%. The unreacted monomer and water were evaporated away using a rotary evaporator to obtain a CR-base latex-U (solid content, 46% by weight; the carboxyl group content relative to the overall polymer in the latex was about 1.1% by weight). The mean particle size of the latex was 96 μm, and the Maron test deposition percentage was 0.0054% by weight. The latex stability was extremely good.

The adhesiveness potency of the obtained CR-base latex-U was evaluated, and the result is shown in Table 3. As compared with the comparative CR-base latex, the peeling strength reduction after the open time and the peeling strength reduction after dipping in water of the latex-U were small, and it is obvious that, as compared with the conventional latex, the adhesiveness and the water resistance of the latex-U are extremely improved.

### Example 19

25.00 g of the aqueous solution-G of CR random copolymer obtained in Synthetic Example 7 (the amount of the hydrophilic group-having CR random copolymer used was ˜7.91 g, and 14% by weight of the monomer), 0.05 g of n-dodecylmercaptan and 50.00 g of chloroprene were put into a 200-ml flask equipped with a nitrogen gas take-in duct and a stirrer, and with stirring, the system was fully pumped with a small amount of a nitrogen flow given thereinto, and then, in a nitrogen atmosphere, this was polymerized at 40° C. with successively adding an aqueous initiator solution (containing 3.00% by weight of potassium persulfate and 0.03% by weight of sodium anthraquinonesulfonate) thereto. After heated for 10 hours, 60 mg of phenothiazine was added to stop the polymerization. The polymerization conversion of chloroprene was 83%. The unreacted monomer and water were evaporated away using a rotary evaporator to obtain a CR-base latex-V (solid content, 46% by weight; the polyethylene glycol content relative to the overall polymer in the latex was about 6.5% by weight). The mean particle size of the latex was 120 μm, and the Maron test deposition percentage was 0.0155% by weight. The latex stability was extremely good.

The adhesiveness potency of the obtained CR-base latex-V was evaluated, and the result is shown in Table 3. As compared with the comparative CR-base latex, the peeling strength reduction after the open time and the peeling strength reduction after dipping in water of the latex-V were small, and it is obvious that, as compared with the conventional latex, the adhesiveness and the water resistance of the latex-V are extremely improved.

### Example 20

40.00 g of the aqueous solution-H of CR random copolymer obtained in Synthetic Example 8 (the amount of the hydrophilic group-having CR random copolymer used was 7.74 g, and 13.4% by weight of the monomer), 0.05 g of n-dodecylmercaptan and 50.00 g of chloroprene were put into a 200-ml flask equipped with a nitrogen gas take-in duct and a stirrer, and with stirring, the system was fully pumped with a small amount of a nitrogen flow given thereinto, and then, in a nitrogen atmosphere, this was polymerized at 40° C. with successively adding an aqueous initiator solution (containing 3.00% by weight of potassium persulfate and 0.03% by weight of sodium anthraquinonesulfonate) thereto. After heated for 10 hours, 60 mg of phenothiazine was added to stop the polymerization. The polymerization conversion of chloroprene was 81%. The unreacted monomer and water were evaporated away using a rotary evaporator to obtain a CR-base latex-W (solid content, 47% by weight; the diethylamino group content relative to the overall polymer in the latex was about 0.7% by weight). The mean particle size of the latex was 115 μm, and the Maron test deposition percentage was 0.0210% by weight. The latex stability was extremely good.

The adhesiveness potency of the obtained CR-base latex-W was evaluated, and the result is shown in Table 3. As compared with the comparative CR-base latex, the peeling strength reduction after the open time and the peeling strength reduction after dipping in water of the latex-W were small, and it is obvious that, as compared with the conventional latex, the adhesiveness and the water resistance of the latex-W are extremely improved.

### Comparative Example 4

Chloroprene was emulsion-polymerized according to the same method as in Example 13 except that 2.65 g (as its existing form) of sodium alkyldiphenylether-disulfonate (manufactured by KAO CORPORATION, PELEX SSH) was added to it in addition to the aqueous solution-A of CR random copolymer thereto in Example 13. After heated for 7 hours, 60 mg of phenothiazine was added to stop the polymerization. The polymerization conversion of chloroprene was 89%. The unreacted monomer and water were evaporated away using a rotary evaporator to obtain a CR-base latex-X (solid content, 47% by weight; the emulsifier content relative to the polymer in the latex was about 3.0% by weight).

The adhesiveness potency of the obtained CR-base latex-X was evaluated, and the result is shown in Table 4. It is obvious that, as compared with the CR-base latex of Examples, the peeling strength reduction after the open time and the peeling strength reduction after dipping in water of the latex-X are great.

TABLE 4

| | | Compara- | | Compara- | Compara- |
|---|---|---|---|---|---|
| Ordinary Peeling | | tive | Comparative | tive | tive |
| Strength (N/25 mm)¹⁾ | | Example 4 | Example 5 | Example 7 | Example 8 |
| open time | 0 hr | 52C/S | 54C/S | 30S/C | 50C/S |
| | 1 hr | 19S | 18S | 13S | 20S/C |
| | 3 hrs | 8S | 9S | 5S | 11S/C |

| | | | | |
|---|---|---|---|---|
| Water-Resistant | 5S | 4S | 1S | 8S |
| Peeling Strength | | | | |
| (N/25 mm)¹⁾ | | | | |

¹⁾Peeling State: C = cohesive failure in the adhesive layer. S = peeling at the adhesive interface.

### Comparative Example 5

Chloroprene was emulsion-polymerized according to the same method as in Example 13 except that 1.30 g of sodium dodecylbenzenesulfonate was used in place of the aqueous solution-A of CR random copolymer used in Example 13. After heated for 7 hours, 60 mg of phenothiazine was added to stop the polymerization. The polymerization conversion of chloroprene was 88%. The unreacted monomer and water were evaporated away using a rotary evaporator to obtain a CR-base latex-Y (solid content, 46% by weight; the emulsifier content relative to the polymer in the latex was about 3.0% by weight).

The adhesiveness potency of the obtained CR-base latex-Y was evaluated, and the result is shown in Table 4. It is obvious that, as compared with the CR-base latex of Examples, the peeling strength reduction after the open time and the peeling strength reduction after dipping in water of the latex-Y are great.

### Comparative Example 6

30.00 g of the aqueous solution-F of CR random copolymer obtained in Synthetic Example 6 (the amount of the hydrophilic group-having CR random copolymer used was 2.58 g, and 5% by weight of the monomer), 0.05 g of n-dodecylmercaptan and 50.00 g of chloroprene were put into a 200-ml flask equipped with a nitrogen gas take-in duct and a stirrer, and the system was fully pumped with applying a small amount a nitrogen flow thereto with stirring, and then, in a nitrogen atmosphere, this was polymerized at 40° C. with successively adding an aqueous initiator solution (containing 3.00% by weight of potassium persulfate and 0.03% by weight of sodium anthraquinonesulfonate) thereto. However, after 20 minutes from the start of heating, the viscosity in the system rapidly increased to give a polymer mass, and therefore the emulsion polymerization was difficult to continue.

### Comparative Example 7

Chloroprene was emulsion-polymerized according to the same method as in Example 13 except that 1.00 g of potassium rosinate was used in place of the aqueous solution-A of CR random copolymer used in Example 13. After heated for 4 hours, 60 mg of phenothiazine was added to stop the polymerization. The polymerization conversion of chloroprene was 91%. The unreacted monomer and water were evaporated away using a rotary evaporator to obtain a CR-base latex-Z (solid content, 46% by weight; the emulsifier content relative to the polymer in the latex was about 3.0% by weight).

The adhesiveness potency of the obtained CR-base latex-Z was evaluated, and the result is shown in Table 4. It is obvious that, as compared with the CR-base latex of Examples, the peeling strength reduction after the open time and the peeling strength reduction after dipping in water of the latex-Z are great.

### Comparative Example 8

Chloroprene was emulsion-polymerized according to the same method as in Example 15 except that 0.50 g of potassium rosinate was used in addition to the aqueous solution-B of CR random copolymer used in Example 15. After heated for 6 hours, 60 mg of phenothiazine was added to stop the polymerization. The polymerization conversion of chloroprene and 2,3-dichloro-1,3-butadiene was 91% and 96%. The unreacted monomer and water were evaporated away using a rotary evaporator to obtain a CR-base latex-AA (solid content, 47% by weight; the emulsifier content relative to the polymer in the latex was about 2.2% by weight).

The adhesiveness potency of the obtained CR-base latex-AA was evaluated, and the result is shown in Table 4. It is obvious that, as compared with the CR-base latex of Examples, the peeling strength reduction after the open time and the peeling strength reduction after dipping in water of the latex-AA are great.

While the invention has been described in detail and with reference to specific embodiments thereof, it will be apparent to one skilled in the art that various changes and modifications can be made therein without departing from the scope thereof.

This application is based on Japanese patent application No. 2006-321500 filed on Nov. 29, 2006, Japanese patent application No. 2007-72065 filed on Mar. 20, 2007, the entire contents thereof being hereby incorporated by reference.

1. A polychloroprene-base latex comprising 2% or less by weight of a conventional emulsifier, and an acid functional group-terminated polychloroprene-type polymer represented by the following formula (1):
(polychloroprene-type polymer)−S—R—X (1)
(wherein X represents a carboxyl group or its salt; R represents an alkyl group, an aryl group, a substituted alkyl group or a substituted aryl group).

2. The polychloroprene-base latex according to claim 1, wherein the acid functional group-terminated polychloroprene-type polymer is a polychloroprene-type polymer obtained through radical polymerization of chloroprene or chloroprene and a radically-polymerizable monomer copolymerizable with chloroprene, in the presence of an acid functional group-having thiol compound represented by the following formula (2), an acid functional group-having disulfide compound represented by the following formula (3), or an acid functional group-having thiol compound represented by the following formula (2) and an acid functional group-having disulfide compound represented by the following formula (3):
H—S—R—X (2)
(wherein X represents a carboxyl group or its salt; R represents an alkyl group, an aryl group, a substituted alkyl group or a substituted aryl group),
X—R—S—S—R—X (3)
(wherein X represents a carboxyl group or its salt; R represents an alkyl group, an aryl group, a substituted alkyl group or a substituted aryl group).

3. The polychloroprene-base latex according to claim 1, wherein the number average molecular weight of the acid functional group-terminated polychloroprene-type polymer, as determined through gel permeation chromatography (GPC), is from 500 to 30,000.

4. A method for producing a polychloroprene-base latex according to claim 1, which comprises emulsifying chloroprene in water in the presence of a hydrophilic solvent by the use of an acid functional group-terminated polychloroprene-type polymer represented by the following formula (1) therein, and subjecting it to emulsion polymerization with a radical initiator added thereto:
(polychloroprene-type polymer)−S—R—X (1)

5. The method for producing a polychloroprene-base latex according to claim 4, wherein the hydrophilic solvent is at least one solvent selected from acetone, methyl ethyl ketone, methoxyethanol, tetrahydrofuran, isopropanol, ethanol.

6. A polychloroprene-base latex comprising 2% or less by weight of a conventional emulsifier, and a polychloroprene-base random copolymer with hydrophilic group.

7. The polychloroprene-base latex according to claim 6, wherein the polychloroprene-base random copolymer with hydrophilic group is a random copolymer obtained through polymerization of chloroprene or chloroprene and a radically-polymerizable monomer copolymerizable with chloroprene, with a radically-polymerizable monomer with hydrophilic group.

8. The polychloroprene-base latex according to claim 7, wherein the radically-polymerizable monomer with hydrophilic group is a monomer selected from maleic acid, maleic anhydride, maleate, citraconic anhydride, fumaric acid, fumarate, methacrylic acid, acrylic acid, styrenesulfonic acid, vinylbenzoic acid, vinylacetic acid.

9. The polychloroprene-base latex according to claim 6, wherein the number average molecular weight of the polychloroprene-base random copolymer with hydrophilic group, as determined through gel permeation chromatography (GPC), is 100,000 or less.

10. A method for producing a polychloroprene-base latex according to claim 6, which comprises using a polychloroprene-base random copolymer with hydrophilic group in producing a polychloroprene-base latex through emulsion polymerization of chloroprene or chloroprene and a monomer copolymerizable with chloroprene.

11. The method for producing a polychloroprene-base latex according to claim 10, wherein the polychloroprene-base random copolymer with hydrophilic group is a random copolymer obtained through polymerization of chloroprene or chloroprene and a radically-polymerizable monomer copolymerizable with chloroprene, with a radically-polymerizable monomer with hydrophilic group.

12. An adhesive, a primer, a sealant, a binder and a coating agent, comprising a polychloroprene-base latex according to claim 1 or 6.
